(19) United States
(12) Patent Application Publication
(10) Pub. No.: US 2018/0316920 A1
(43) Pub. Date: Nov. 1, 2018

(54) VIDEO IMAGE ENCODING DEVICE, VIDEO IMAGE ENCODING METHOD AND PROGRAM RECORDING MEDIUM

(71) Applicant: NEC Corporation, Tokyo (JP)

(72) Inventor: Hiroaki IGARASHI, Tokyo (JP)

(73) Assignee: NEC Corporation, Tokyo (JP)

(21) Appl. No.: 15/771,560

(22) PCT Filed: Oct. 19, 2016
(86) PCT No.: PCT/JP2016/004631

§ 371 Date: Apr. 27, 2018

(30) Foreign Application Priority Data
Oct. 28, 2015 (JP) 2015-211659
Aug. 4, 2016 (JP) 2016-153570

(51) Int. Cl. H04N 19/124; H04N 19/176; H04N 19/436; H04N 19/44

(52) U.S. Cl. CPC H04N 19/124; H04N 19/45; H04N 19/436; H04N 19/176

(57) ABSTRACT

A video image encoding device includes a generator that generates position information indicating, for each size of an image block, a position of each of a plurality of image blocks in an image, and an image processor that executes transform processing for an image block of a predetermined size at a position indicated by the generated position information.

### TECHNICAL FIELD

The present invention relates to a video image encoding device, a video image encoding method, and a program recording medium. The present invention relates to, particularly, a video image encoding device, a video image encoding method, and a program recording medium that are capable of executing data-dependent processing in parallel, without decreasing efficiency of parallel processing.

### BACKGROUND ART

With resolution enhancement of a video image represented by a resolution degree of so-called 4K or 8K, a video image encoding technique having higher encoding efficiency has been highly demanded. An example of the video image encoding technique includes H.264/Moving Picture Experts Group (MPEG)-4 Advanced Video Coding (AVC) (hereinafter, abbreviated as H.264) cooperatively standardized by International Telecommunication Union (ITU) and International Organization for Standardization (ISO). Further, as another example of the video image encoding technique, there is a H.265 High Efficiency Video Coding (HEVC) (hereinafter, abbreviated as H.265) standardized in 2013.

An encoding of H.264 and H.265 includes a prediction for reducing redundancy between frames or redundancy in a frame, a transform/quantization for transforming a spatial component of a prediction residue to a frequency component and reducing spatial redundancy, and an entropy encoding method for assigning a variable-length code to an appearance frequency of data. The encoding method of H.264 and H.265 is referred to also as a hybrid encoding method. Encoding efficiency of H.265 is twice encoding efficiency of H.264. Due to high encoding efficiency, in H.265, an amount of calculation regarding encoding is also largely increased.

In H.265, encoding is executed in a unit of a coding unit (CU). Further, prediction is executed in a unit of a prediction unit (PU), and transform is executed in a unit of a transform unit (TU). In H.265, the number of processable patterns for each block is increased, compared with H.264, and therefore more appropriate encoding is executed.

For example, as patterns of a TU in H.264, there are two patterns of 4×4 and 8×8. As patterns of a TU in H.265, there are four patterns of 4×4, 8×8, 16×16, and 32×32, and two patterns are added, compared with H.264. Note that 4×4 or the like represents a size of a TU. For example, 4×4 refers to a TU including four pixels in a vertical direction and four pixels in a lateral direction. The number of processable patterns of a TU is increased, and thereby, in encoding executed based on the standardization of H.265, various TUs are mixed on a screen to be processed.

As an example of a video image encoding device, PTL 1 describes an image encoding device that selects an optimum mode and a quantization parameter for encoding efficiency.

Further, NPL 1 describes a content of processing based on the standardization of H.265. One example of a configuration of a video image encoding device (encoder) based on the standardization of H.265 is illustrated in FIG. 23. FIG. 23 is a block diagram illustrating a configuration example of a video image encoding device based on the standardization of H.265.

A video image encoding device 100 illustrated in FIG. 23 includes an intra-prediction unit 1000, an inter-prediction unit 2000, a transform processing unit 3000, an entropy encoding unit 4000, a subtractor 5000, an adder 6000, a multiplexer 7000, and a multiplexer 8000.

The intra-prediction unit 1000 includes a function of executing prediction processing of reducing redundancy in a frame for a spatial component of an input image. The inter-prediction unit 2000 includes a function of executing prediction processing of reducing redundancy between frames for a spatial component of an input image. The intra-prediction unit 1000 and the inter-prediction unit 2000 output a prediction image generated by prediction processing.

The transform processing unit 3000 executes transform processing of transforming a spatial component of a residual image that is a difference between an input image and a prediction image to a frequency component. The transform processing unit 3000 outputs a transform coefficient generated by transform processing.

Further, the transform processing unit 3000 inversely transforms a transform coefficient to pixel information for the inter-prediction unit 2000 that uses an image of a previous frame. The adder 6000 adds the inversely transformed pixel information to a prediction image, and thereby acquires a reconstructed image. The acquired reconstructed image is input to the inter-prediction unit 2000 as illustrated in FIG. 23.

The entropy encoding unit 4000 includes a function of scanning a transform coefficient, causing the transform coefficient to be subjected to variable-length encoding, based on an appearance probability of data, and outputting a bit stream. Frequency component information transformed to a format that is easily encoded in the transform processing unit 3000 is input to the entropy encoding unit 4000 as a bit stream. The entropy encoding unit 4000 encodes the input bit stream, for example, based on an appearance probability of “0” or “1”.

Further, in the video image encoding device 100 illustrated in FIG. 23, a coded block flag (CBF) is set in a unit of a TU. A series of processing of transform processing, quantization processing, inverse transform processing, and inverse quantization processing may not be executed for a TU set to be CBF=0. The CBF is set to be 0 for a TU in which it is determined that a residual image is not needed in inter-prediction processing, for example, in reference software HEVC Test Model (HM) based on the standardization of H.265 described in NPL 2.

FIG. 24 is a block diagram illustrating a configuration example of the transform processing unit 3000 illustrated in FIG. 23. The transform processing unit 3000 illustrated in FIG. 24 includes a transform/quantization unit 3100 and an inverse transform/inverse quantization unit 3200.

The transform/quantization unit 3100 transforms, as described above, a spatial component of an input residual image to a frequency component and generates a transform coefficient corresponding to the transform result. Then, the transform/quantization unit 3100 quantizes the transform coefficient and inputs the quantized transform coefficient to the inverse transform/inverse quantization unit 3200.

The inverse transform/inverse quantization unit 3200 reconstructs an image, based on the input transform coefficient in such a way that an image encoded once is used in inter-prediction processing for a next frame. The inverse transform/inverse quantization unit 3200 inversely quantizes the quantized transform coefficient, being a frequency component, input from the transform/quantization unit 3100. Then, the inverse transform/inverse quantization unit 3200 inversely transforms the inversely quantized transform coefficient to a spatial component.

Transform/quantization executed by the transform processing unit 3000 illustrated in FIG. 24 is described below. In the standardization of H.265, as a transform method, integer discrete cosine transform (DCT) and integer discrete sine transform (DST) are employed.

Transform processing is executed for each TU. In the standardization of H.265, orthogonal transform having integer accuracy is defined, in any of DCT and DST. In other words, a processing result of transform processing is a matrix product of a pixel value included in a TU and a transform matrix defined for each size of the TU (hereinafter, referred to as a “TU size”). The processing result is a matric product in a unit of a TU, and therefore the transform processing is depending on a relation between pixels in a row unit or in a column unit. Note that a specific content of a transform equation is described in NPL 1.

Quantization processing is executed based on an input quantization parameter. The quantization processing does not depend on a relation between pixels. Inverse transform processing is inverse processing to transform processing, and inverse quantization processing is inverse processing to quantization processing.

In signal processing such as video image encoding, an amount of processing is large. Further, video image encoding is processing executed at a high degree of parallelism. Therefore, it is necessary for video image encoding to be executed in parallel processing at high speed.

An example of the parallel processing is parallel processing using a many-core architecture such as a graphics processing unit (GPU). The parallel processing using a many-core architecture is referred to as general purpose computing on graphics processing units (GPGPU).

A central processing unit (CPU) includes several processor cores to several tens of processor cores, but a GPU includes several thousands of processor cores. Therefore, the GPU can realize processing having a high degree of parallelism.

An architecture of a GPU represented by a product of NVIDIA Corporation is referred to as a single instruction multiple thread (SIMT) architecture. The SIMT architecture can execute an instruction for a plurality of threads at a time.

In a Kepler architecture by NVIDIA corporation that is one type of the SIMT architecture, for example, one batch of 32 threads is referred to as a warp. In the Kepler architecture, an instruction is executed in a warp unit. In other words, when even one thread of 32 threads executes different processing, another thread of the same warp is stalled. Note that the stall is a state in which an action is stopped and an operation is not accepted. Therefore, the SIMT architecture is a technique suitable for realizing an application for executing the same processing for a large amount of data.

When video image encoding as based on the standardization of H.264 and the standardization of H.265 is realized by a many-core architecture such as a GPU, block matching and the like used in prediction processing can be executed in parallel in a unit of a pixel and therefore is executed efficiently at a high degree of parallelism.

However, transform processing in video image encoding is depending on a relation between pixels between rows or a relation between pixels between columns in a TU, and therefore execution at a high degree of parallelism is difficult and processing efficiency is decreased. Further, transform processing is depending on a size of a TU, and therefore allocation of transform processing for each TU to each thread is complex.

PTL 2 describes a decoding method in which a plurality of processing units executes processing in a macro block unit for encoded image data to be processed. The decoding method described in PTL 2 is characterized by collectively executing blocks having a dependency relation in order to reduce communication between processors. However, in the decoding method described in PTL 2, it is not assumed that processing is allocated in such a way that processes handled by processors are equalized.

A disposition example of transform blocks based on the standardization of H.264 is illustrated in FIG. 25. FIG. 25 is an illustrative diagram illustrating a disposition example of transform blocks based on the standardization of H.264. As illustrated in FIG. 25, an image to be processed is configured with 4×4 or 8×8.

As illustrated in FIG. 25, in H.264, as a disposition pattern of a TU for a macro block, there are only two types of a pattern in which 16 4×4s are disposed and a pattern in which 4 8×8s are disposed. When one thread is allocated to one column or one row, a degree of parallelism of a pattern in which 4×4s are disposed is 64. Further, a degree of parallelism of a pattern in which 8×8s are disposed is 32.

In other words, a degree of parallelism for each macro block is equal to or more than 32 in any of the disposition patterns. Therefore, processing for one macro block is allocated to one warp. Therefore, in transform/quantization processing based on the standardization of H.264 upon using a warp, an overhead is not generated.

In H.265, the number of patterns of a TU is increased, and therefore, it is difficult to allocate transform processing to threads in such a way that an overhead is not generated. A disposition example of a transform block based on the standardization of H.265 is illustrated in FIG. 26. FIG. 26 is an illustrative diagram illustrating a disposition example of a transform block based on the standardization of H.265.

As illustrated in FIG. 26, an image to be processed may include TUs of all patterns of 4×4, 8×8, 16×16, and 32×32. Further, a TU of 8×8 is set to be CBF=0, and there is a TU for which transform processing, quantization processing, inverse transform processing, and inverse quantization processing do not need to be executed. In the present example, there is a possibility that, even in TUs of any pattern, there may be a TU for which transform processing and the like do not need to be executed.

An arrow in each TU illustrated in FIG. 26 represents a thread for transforming each TU. One thread is allocated to one TU. Note that a thread is not allocated to a TU set to be CBF=0, and therefore an arrow is not illustrated.

FIG. 27 is a time chart illustrating an example of a processing timing of transform processing based on the standardization of H.265. FIG. 27 is a time chart in which a thread is allocated as illustrated in FIG. 26 and transform processing is executed. An arrow illustrated in FIG. 27 represents transform processing of a TU by a thread. Further, a blank illustrated in FIG. 27 represents a period in which a thread is stalled.

As described above, when an instruction is executed in a warp unit, it is required to allocate the same processing to all processing-execution threads in 32 threads. Transform processing is depending on a size of a TU, and therefore all sizes of TUs transformable by a warp at a time are inevitably the same.

Specifically, as illustrated in FIG. 27, at t=0, one TU of 32×32 is transformed. Further, at t=1, one TU of 16×16 is transformed. At t=2, six TUs of 8×8 are transformed. When sizes are the same, processing is the same, and therefore processing for a TU of CBF=0 is also allocated, together with transform processing for a TU to be executed. At t=3, 24 TUs of 4×4 are transformed. Note that threads for transforming respective TUs are different.

As illustrated in FIG. 27, it is impossible for an architecture such as SIMT to transform TUs having different sizes at the same time. In other words, a large overhead is generated in transform processing. The reason is as follows.

A granularity of a thread illustrated in FIG. 27 is large, but even when a granularity of a thread is small, it is required to allocate one thread to one column or one row. When one thread is allocated to one column or one row, a degree of parallelism of transform processing for a TU of 4×4 having a minimum size is 4. In other words, it is conceivable that, in transform processing based on the standardization of H.265, a degree of parallelism per block may be small, and therefore, it is often difficult to allocate the same processing to 32 threads.

Further, in video image encoding based on the standardization of H.265, a transform block is adaptively disposed, and therefore it is highly possible that a pattern in which 32 or more transform processes do not occur is generated. When a pattern in which 32 or more transform processes do not occur is generated, it is difficult for a GPU to efficiently process an image to be encoded.

NPL 3 describes one example of a technique that solves the above-described problem and is applicable to a transform processing unit. FIG. 28 is a block diagram illustrating a configuration example of a transform processing unit 3000 applied with the technique described in NPL 3.

NPL 3 describes a technique for a decoder based on the standardization of H.264. NPL 3 describes a technique for collecting, in order to allocate the same processing to each thread, pieces of data having the same TU size in a temporary area and allocating the same processing to all threads by collectively processing the pieces of data. In FIG. 28, a transform processing unit in which the transform processing unit described in NPL 3 is expanded for an encoder that executes transform/quantization processing is described.

The transform processing unit 3000 illustrated in FIG. 28 includes a transform/quantization unit 3101 to a transform/quantization unit 310N, inverse transform/inverse quantization units 3201 to 320N, a gather unit 3900, and scatter units 3910 to 3920.

Note that the transform/quantization units 3101 to 310N and the inverse transform/inverse quantization units 3201 to 320N are included correspondingly to the number of patterns of TUs, respectively. In other words, N is equivalent to the number of patterns of TUs. Each unit processes a TU having a corresponding size.

An example of an operation of the transform processing unit 3000 illustrated in FIG. 28 is described below. A residual image and TU size information indicating of TUs configuring the residual image are input to the gather unit 3900. The gather unit 3900 collectively stores pieces of data of the input residual image in a temporary area (not illustrated) for each TU size by using the input TU size information.

The transform/quantization units 3101 to 310N execute transform/quantization processing for the pieces of data of the residual image stored in the temporary area, the pieces of data corresponding to TU sizes to be processed by the respective units. Data are stored in the temporary area for each TU size, and therefore the transform/quantization units 3101 to 310N can efficiently execute parallel processing. Each transform/quantization unit writes back a generated transform coefficient to the temporary area.

The inverse transform/inverse quantization units 3201 to 320N execute inverse transform/inverse quantization processing (inverse transform processing and inverse quantization processing) for pieces of data of the transform coefficients stored in the temporary area, the pieces of data corresponding to the TU sizes to be processed by the respective units. A transform coefficient is stored in the temporary area for each TU size, and therefore, similarly to the transform/quantization units 3101 to 310N, the inverse transform/inverse quantization units 3201 to 320N can also efficiently execute parallel processing. The inverse transform/inverse quantization units 3201 to 320N write back a part of a generated reconstructed image to the temporary area.

The scatter unit 3910 writes back a part of the reconstructed image for each TU size reconstructed in the inverse transform/inverse quantization units 3201 to 320N from the temporary area to the original area. Further, the scatter unit 3920 writes back a transform coefficient for each TU size generated in each of the transform/quantization units 3101 to 310N from the temporary area to the original area.

Note that scatter processing and gather processing are sequential processing, and therefore the gather unit 3900, the scatter unit 3910, and the scatter unit 3920 are realized mainly by a CPU suitable for executing sequential processing. Further, the transform/quantization units 3101 to 310N and the inverse transform/inverse quantization units 3201 to 320N are realized mainly by a GPU suitable for executing parallel processing.

As described above, each transform/quantization unit and each inverse transform/inverse quantization unit illustrated in FIG. 28 collectively process only pieces of data relating to TUs having the same size, respectively. In other words, when the transform processing unit 3000 illustrated in FIG. 28 is realized by a GPU, a plurality of the same processes are allocated to a warp for executing transform/quantization processing and inverse transform/inverse quantization processing.

FIG. 29 is a time chart illustrating another example of a processing timing of transform processing based on the standardization of H.265. FIG. 29 illustrates a time chart in which the transform processing unit 3000 illustrated in FIG. 28 executes transform processing for TUs of the disposition example illustrated in FIG. 26.

When the transform processing unit 3000 executes transform processing as illustrated in FIG. 29, a warp is divided for each TU size and threads to be used are packed. Therefore, the number of stalled threads is decreased, and thereby transform processing is more efficiently executed. Note that, when the number of TUs to be processed is not a multiple of the number of threads with respect to one warp, a stalled thread is generated.

As described above, in H.264 dealt with in NPL 2, even when a warp for executing transform/quantization processing is allocated to a macro block, an overhead is not generated. NPL 2 describes respective evaluations of performance of a configuration that sequentially processes two types of TUs as illustrated in FIG. 27 and performance of a configuration that processes in parallel two types of TUs as illustrated in FIG. 29. NPL 2 describes that the performance of the configuration that executes parallel processing is more excellent.

The reason is that, as described above, in H.264, when a warp is allocated to a macro block, all threads in the warp execute the same processing, and thereby transform processing is executed without an overhead.

In H.265, since TUs having different degrees of parallelism are adaptively disposed, it is difficult to allocate processing to a thread in such a way that all threads in a warp execute the same processing, and therefore it is difficult to execute efficient transform processing. Therefore, in an encoding method in which a TU is adaptively disposed as in H.265, it is conceivable that the technique described in NPL 3 illustrated in FIG. 28 is specifically effective.

Note that PTL 4 describes that a method for analyzing an image includes a step of recording coordinates of an image block.

### CITATION LIST

### Patent literature

[PTL 1] Japanese Laid-open Patent Publication No. 2006-121538

[PTL 2] International Publication No. WO 2008/020470

[PTL 3] International Publication No. WO 2014/167609

[PTL 4] Japanese Laid-open Patent Publication No. 2012-074078

### Non Patent literature

[NPL 1] ITU-T Recommendation H.265 “High efficiency video coding”, April 2013

[NPL 2] JCTVC (Joint Collaborative Team on Video Coding)-S1002, “High Efficiency Video Coding (HEVC) Test Model 16 (HM16) Improved Encoder Description”

[NPL 3] Q. Chen, H. Wang, S. Zhuang, and B. Liu, “Parallel algorithm of IDCT with GPUs and CUDA for large-scale video quality of 3G”, Journal of computers, vol. 7, No. 8, pp. 1880 to 1886, August 2012

[NPL 4] M. Harris, S. Sengupta, J. D. Owens, “GPU Gems 3”, Chapter 39

### SUMMARY OF INVENTION

### Technical Problem

A first problem of the transform processing unit described in NPL 3 is that a gather unit needs to include a temporary area. The gather unit 3900 illustrated in FIG. 28, for example, needs to gather pieces of data for each TU size. The gather unit 3900 stores pieces of data in a temporary area for each TU size and therefore needs to include a temporary area with a size of an original image at a maximum level.

In other words, when an area for storing an input residual image itself is also included, the transform processing unit 3000 illustrated in FIG. 28 needs to include an area at least twice the area for the residual image in some cases. With an increase in a size of an image to be processed, a transform processing unit including a larger area is needed, resulting in an extra cost.

A second problem of the transform processing unit described in NPL 3 is that communication generated between a CPU and a GPU is a large bottleneck. In processing for an image having a high resolution such as 4K and 8K, specifically a large bottleneck results.

Processing executed by each of the gather unit 3900, the scatter unit 3910, and the scatter unit 3920 is sequential processing. Therefore, when a scatter unit and a gather unit are realized by a massively parallel architecture such as an SIMT architecture, it is difficult to efficiently execute processing. The reason is that it is difficult for a massively parallel architecture to efficiently execute sequential processing. In the example described in NPL 3, each of the gather unit 3900, the scatter unit 3910, and the scatter unit 3920 is realized by a CPU.

In the above-described case, each transform/quantization unit and each inverse transform/inverse quantization unit are realized by a GPU, and therefore a large amount of communication is generated between a CPU and a GPU. Since the generated amount of communication is large to the extent of being a bottleneck, a transform processing unit in which all components are realized by a GPU and generation of communication unrelated to execution of original video image encoding processing is suppressed is required.

Therefore, an object of the present invention is to provide a video image encoding device, a video image encoding method, and a program recording medium that solve the problems as described above and are capable of executing video image encoding processing in parallel, without decreasing efficiency of parallel processing.

### Solution to Problem

An aspect of the invention is a video image encoding device. The video image encoding device comprises generation means for generating position information indicating, for each size of an image block, a position of each of a plurality of image blocks in an image; and image processing means for executing transform processing for an image block of a predetermined size at a position indicated by the generated position information.

Another aspect of the invention is a video image encoding method. The video image encoding method comprises generating position information indicating, for each size of an image block, a position of each of a plurality of image blocks in an image; and executing transform processing for an image block of a predetermined size at a position indicated by the generated position information.

Another aspect of the invention is a computer-readable program recording medium. The computer-readable program recording medium records a program causing a computer to execute: generation processing of generating position information indicating, for each size of an image block, a position of each of a plurality of image blocks in an image; and transform processing for an image block of a predetermined size at a position indicated by the position information.

### Advantageous Effects of Invention

According to the present invention, video image encoding processing can be executed in parallel, without decreasing parallel processing efficiency.

### BRIEF DESCRIPTION OF DRAWINGS

FIG. 1 is a block diagram illustrating a configuration example of a first example embodiment of a transform processing unit according to the present invention.

FIG. 2 is a block diagram illustrating a configuration example of a list generation unit 3300.

FIG. 3 is an illustrative diagram illustrating an example of an execution TU list generated by the list generation unit 3300.

FIG. 4 is a flowchart illustrating transform/quantization processing executed by a transform processing unit 3000 of the first example embodiment.

FIG. 5 is a flowchart illustrating list generation processing executed by the list generation unit 3300.

FIG. 6 is a block diagram illustrating a configuration example of a second example embodiment of the transform processing unit according to the present invention.

FIG. 7 is a flowchart illustrating transform/quantization processing executed by a transform processing unit 3000 of the second example embodiment.

FIG. 8 is a block diagram illustrating a configuration example of a third example embodiment of the transform processing unit according to the present invention.

FIG. 9 is a flowchart illustrating transform/quantization processing executed by a transform processing unit 3000 of the third example embodiment.

FIG. 10 is a block diagram illustrating a configuration example of a fourth example embodiment of the transform processing unit according to the present invention.

FIG. 11 is a block diagram illustrating a configuration example of a list update unit 3600.

FIG. 12 is an illustrative diagram illustrating an example of migration processing of execution TU information in a list executed by a list migration unit 3620.

FIG. 13 is an illustrative diagram illustrating another example of migration processing of execution TU information in a list executed by the list migration unit 3620.

FIG. 14 is an illustrative diagram illustrating still another example of migration processing of execution TU information in a list executed by the list migration unit 3620.

FIG. 15 is a flowchart illustrating transform/quantization processing executed by a transform processing unit 3000 of the fourth example embodiment.

FIG. 16 is a flowchart illustrating list update processing executed by the list update unit 3600.

FIG. 17 is a block diagram illustrating a configuration example of a fifth example embodiment of the transform processing unit according to the present invention.

FIG. 18 is a block diagram illustrating a configuration example of a list initiation unit 3700.

FIG. 19 is a flowchart illustrating transform/quantization processing executed by a transform processing unit 3000 of the fifth example embodiment.

FIG. 20 is a flowchart illustrating list initiation processing executed by the list initiation unit 3700.

FIG. 21 is a block diagram illustrating a configuration example of an information processing device capable of realizing functions of a video image encoding device according to the present invention.

FIG. 22 is a block diagram illustrating an outline of the video image encoding device according to the present invention.

FIG. 23 is a block diagram illustrating a configuration example of a video image encoding device based on the standardization of H.265.

FIG. 24 is a block diagram illustrating a configuration example of a transform processing unit 3000 illustrated in FIG. 23.

FIG. 25 is an illustrative diagram illustrating a disposition example of transform blocks based on the standardization of H.264.

FIG. 26 is an illustrative diagram illustrating a disposition example of transform blocks based on the standardization of H.265.

FIG. 27 is a time chart illustrating an example of a processing timing of transform processing based on the standardization of H.265.

FIG. 28 is a block diagram illustrating a configuration example of a transform processing unit 3000 applied with the technique described in NPL 3.

FIG. 29 is a time chart illustrating another example of a processing timing of transform processing based on the standardization of H.265.

FIG. 30 is a block diagram illustrating a configuration example of a sixth example embodiment of the transform processing unit according to the present invention.

FIG. 31 is a block diagram illustrating a configuration example of an expanded list generation unit 4100.

FIG. 32 is a flowchart illustrating transform/quantization processing executed by a transform processing unit 3000 of the sixth example embodiment.

FIG. 33 is a flowchart illustrating expanded list generation processing executed by the expanded list generation unit 4100.

FIG. 34 is an illustrative diagram illustrating a relation between an expanded list and intermediate data.

FIG. 35 is an illustrative diagram illustrating a compression order of transform coefficients.

FIG. 36 is a block diagram illustrating an outline of a video image encoding device according to the present invention.

FIG. 37 is a diagram illustrating one example of a calculation method for an index.

### DESCRIPTION OF EMBODIMENTS

### First Example Embodiment

### [Configuration]

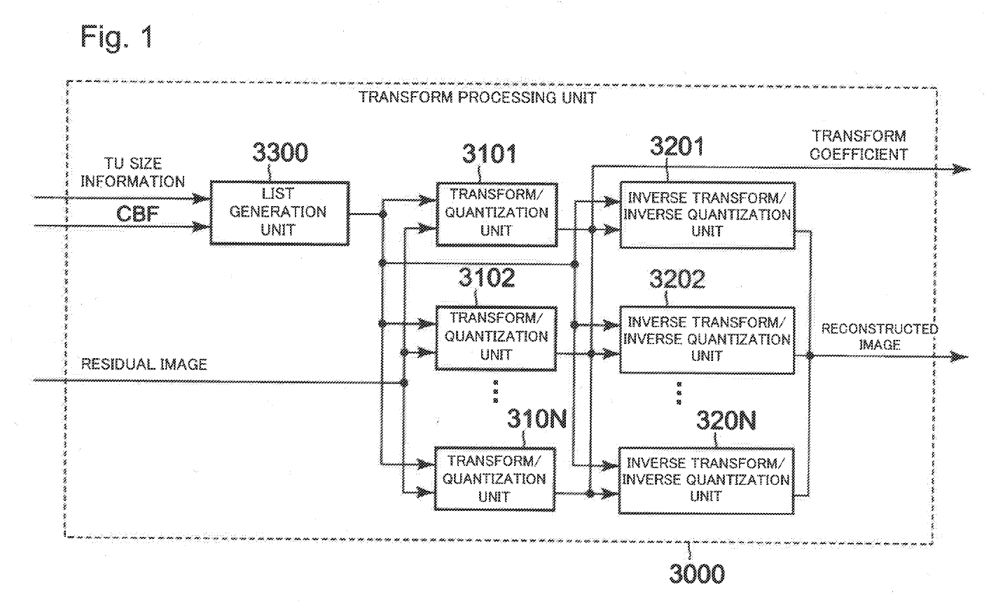

An example embodiment of the present invention will be described below with reference to the drawings. FIG. 1 is a block diagram illustrating a configuration example of a transform processing unit according to a first example embodiment of the present invention. Note that while TU size patterns of H.265 are four types of 4×4, 8×8, 16×16, and 32×32, it is assumed that TU size patterns of the present example embodiment are N types. Further, an arrow illustrated in block diagrams of FIG. 1 and the following figures indicates one example of a flow of information and is not intended to limit a flow of information.

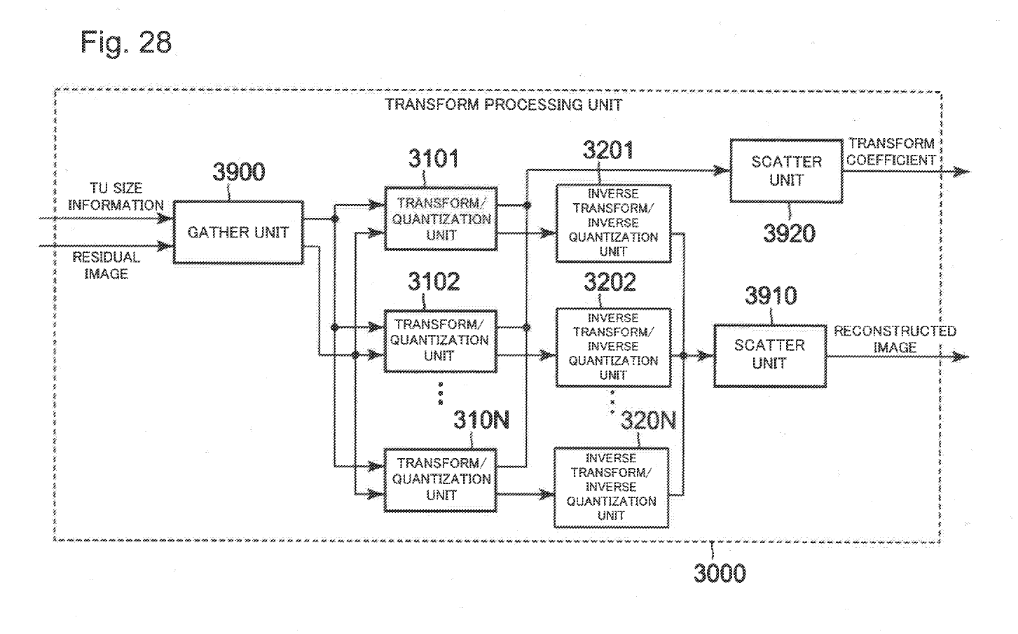

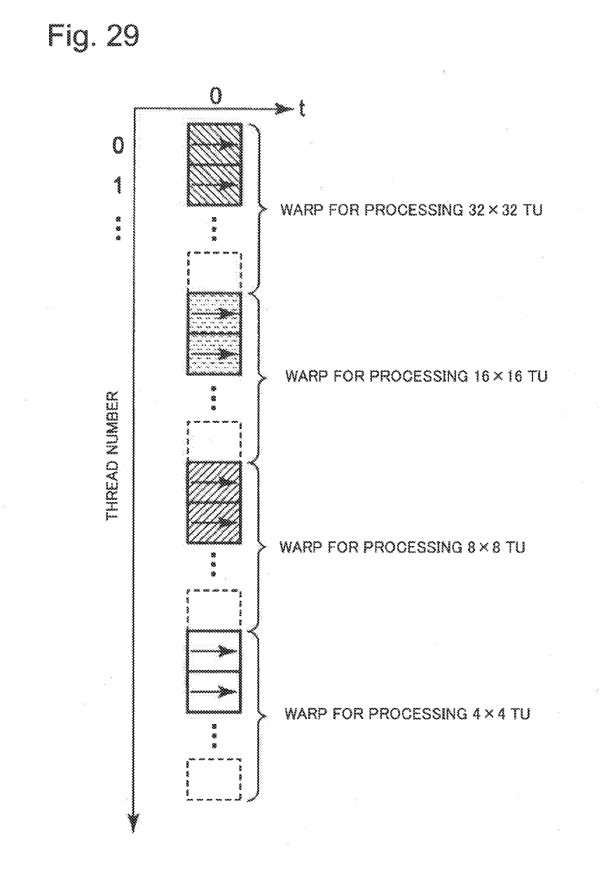

As illustrated in FIG. 1, a transform processing unit 3000 of a video image encoding device of the present example embodiment does not include a gather unit 3900 and scatter units 3910 to 3920, differently from the transform processing unit 3000 illustrated in FIG. 28. In the present example embodiment, a temporary area is not used, and therefore a scatter unit that writes back image data stored in a temporary area to an original area is not included.

Further, the transform processing unit 3000 illustrated in FIG. 1 includes a list generation unit 3300, differently from the transform processing unit 3000 illustrated in FIG. 28. A configuration of the transform processing unit 3000 illustrated in FIG. 1 is similar to the configuration of the transform processing unit 3000 illustrated in FIG. 28, except the list generation unit 3300. TU size information and a residual image are input to the gather unit 3900. In contrast, TU size information and a CBF are input to the list generation unit 3300.

Further, to each of the transform/quantization units 3101 to 310N illustrated in FIG. 28, addresses of temporary areas where residual images of TU sizes and the numbers of execution TU sizes corresponding to the units are input, respectively. In contrast, a residual image and an execution TU list are input to each of the transform/quantization units 3101 to 310N illustrated in FIG. 1. Similar data are input to each of inverse transform/inverse quantization units 3201 to 320N.

The list generation unit 3300 of the present example embodiment includes a function of generating, using a CBF and TU size information as input, an execution TU list that is a list in which position coordinates of TUs are listed for each TU size. In the present example embodiment, the list generation unit 3300 generates a list in which position coordinates are listed, and therefore an operation such as processing for data of an input residual image is not necessary. The reason is that each of the transform/quantization units 3101 to 310N can search, using information of a list corresponding to a TU of a size to be processed, a TU of a size to be processed in a residual image.

Note that the list generation unit 3300 can generate in parallel execution TU lists. The list generation unit 3300 can generate in parallel execution TU lists for each area having a minimum size of a TU including 32×32. In other words, when a screen is divided into areas of 32×32 blocks, the list generation unit 3300 can process in parallel the respective 32×32 blocks in the screen.

Each of the transform/quantization units 3101 to 310N of the present example embodiment executes transform/quantization processing for a plurality of TUs of a corresponding pattern. Therefore, when the transform/quantization units 3101 to 310N are realized by an SIMT architecture such as a GPU, TUs having the same size are allocated to a warp and parallel processing is efficiently executed.

Further, pieces of data to be processed may discontinuously exist on a memory. In a single instruction multiple data (SIMD) instruction used in a CPU, pieces of data continuously existing on a memory are collectively processed, and therefore when pieces of data discontinuously existing on a memory are processed, parallel processing efficiency is decreased.

However, in an SIMT architecture such as a GPU, threads have registers independently of each other, and each thread stores an address to be executed in an own register. In other words, regardless of whether pieces of data to be processed continuously exist on a memory, there is also an advantage that parallel processing is efficiently executed.

The inverse transform/inverse quantization units 3201 to 320N of the present example embodiment execute inverse transform/inverse quantization processing for a plurality of TUs of a corresponding pattern. Therefore, when the inverse transform/inverse quantization units 3201 to 320N are realized by an SIMT architecture such as a GPU, transform coefficients of TUs having the same size are allocated to a warp, and parallel processing is efficiently executed.

Further, while pieces of data to be processed similarly to the above may discontinuously exist on a memory, regardless of whether pieces of data to be processed continuously exist on a memory, in an SIMT architecture such as a GPU, parallel processing is efficiently executed.

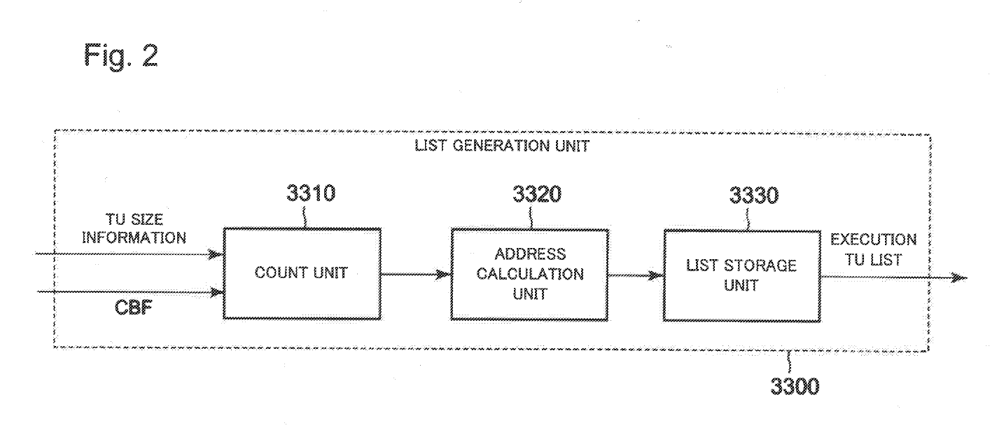

FIG. 2 is a block diagram illustrating a configuration example of the list generation unit 3300. As illustrated in FIG. 2, the list generation unit 3300 includes a count unit 3310, an address calculation unit 3320, and list storage unit 3330.

The count unit 3310 includes a function of counting TUs to be executed (i.e. CBF≠1) in an allocated area for each TU size by using input TU size information and CBFs. Note that the area is an area of a divided residual image allocated in such a way that list generation processing is executed in parallel.

The address calculation unit 3320 includes a function of calculating each address of a list in which each piece of execution TU information is stored in an allocated area.

The list storage unit 3330 includes a function of writing each piece of execution TU information in each address of a list determined by the address calculation unit 3320. The execution TU information is generated by the list storage unit 3330. The list storage unit 3330 outputs a list in which all pieces of execution TU information are written as an execution TU list. The execution TU list is input to the transform/quantization unit 3101 to 310N.

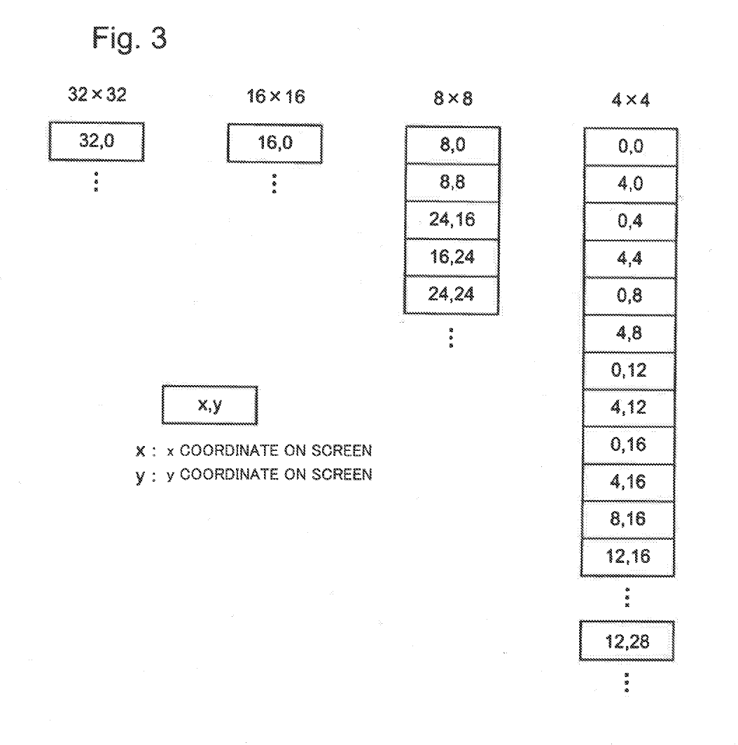

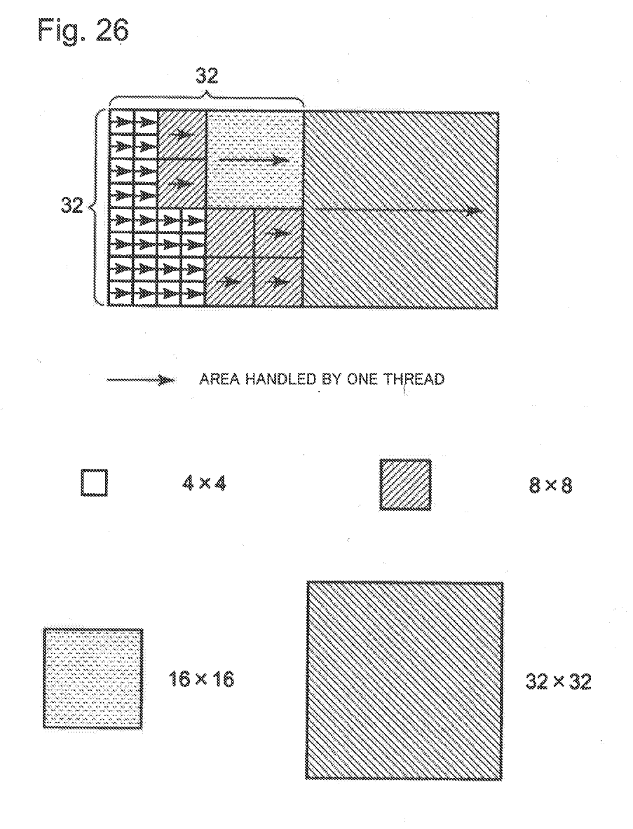

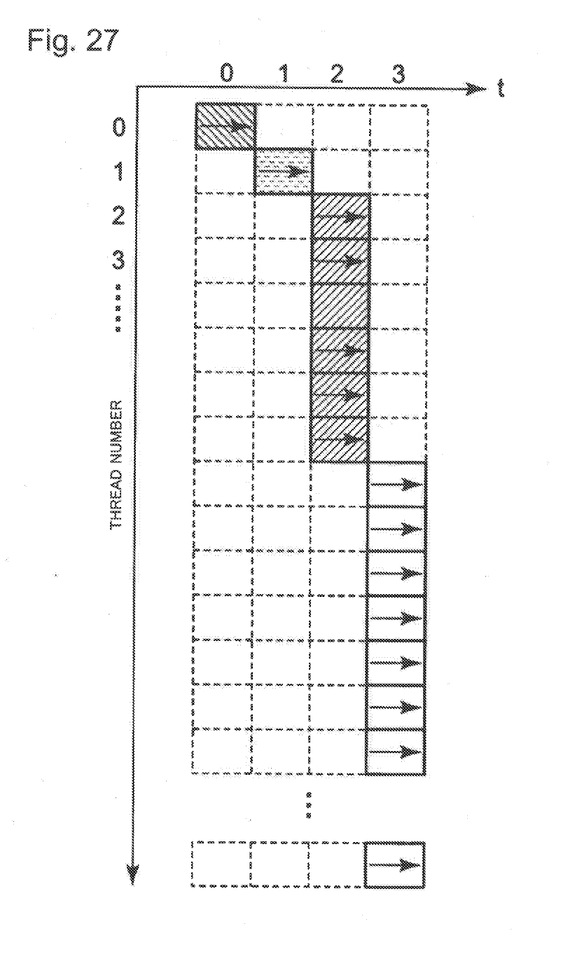

FIG. 3 is an illustrative diagram illustrating an example of an execution TU list generated by the list generation unit 3300. An execution TU list for each TU size illustrated in FIG. 3 is a list generated based on the disposition example of TUs illustrated in FIG. 26.

As illustrated in FIG. 3, execution TU information includes, for example, an x coordinate and a y coordinate of an execution target TU. In an execution TU list, an x coordinate and a y coordinate of an execution target TU in image data are listed. Further, the list generation unit 3300 does not generate execution TU information for a TU set to be CBF=0, and therefore threads necessary for executing transform/quantization processing (transform processing and quantization processing) can be reduced.

### [Operation]

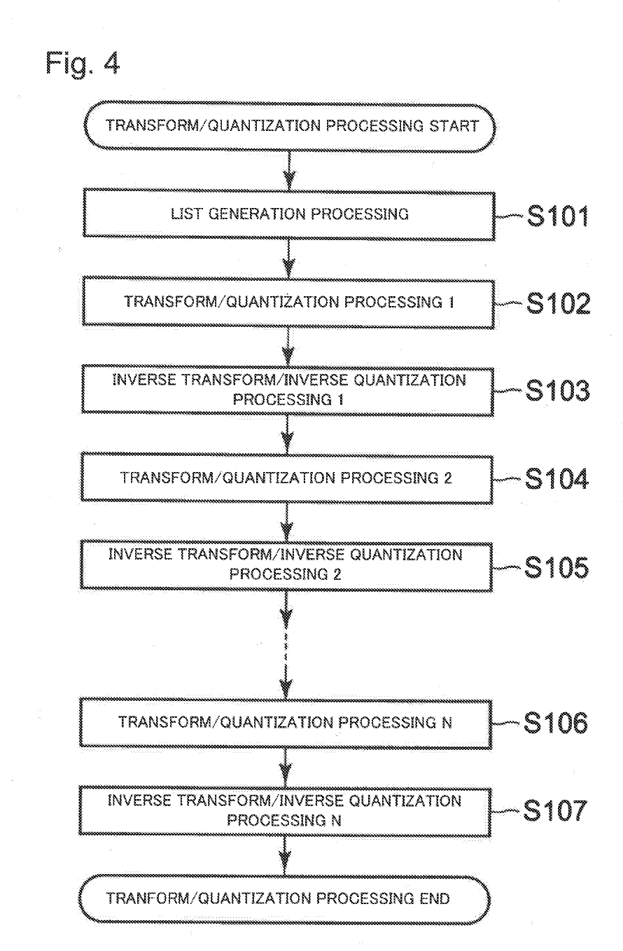

An operation of the transform processing unit 3000 of the present example embodiment will be described below with reference to FIG. 4. FIG. 4 is a flowchart illustrating transform/quantization processing executed by the transform processing unit 3000 of the first example embodiment.

The transform processing unit 3000 accepts input of a residual image and TU size information. The list generation unit 3300 generates an execution TU list in which pieces of execution TU information of TUs in an allocated area are listed for each TU size, based on input CBFs and the input TU size information (step S101).

Then, the transform/quantization unit 3101 collectively executes transform/quantization processing for only TUs regarding a TU size pattern 1, using, as input, a list 1 regarding the TU size pattern 1 in the execution TU list generated in the list generation unit 3300 and the residual image (step S102).

Then, the inverse transform/inverse quantization unit 3201 collectively executes inverse transform/inverse quantization processing (inverse transform processing and inverse quantization processing) for only a transform coefficient regarding the TU size pattern 1, using, as input, transform coefficients output by the transform/quantization unit 3101 (step S103).

Then, the transform/quantization unit 3102 collectively executes transform/quantization processing for only TUs regarding a TU pattern 2, using, as input, a list 2 regarding a TU size pattern 2 in the execution TU list generated in the list generation unit 3300 and a residual image (step S104).

Then, the inverse transform/inverse quantization unit 3202 accepts input of transform coefficients output by the transform/quantization unit 3102 and collectively executes inverse transform/inverse quantization processing for only transform coefficients regarding the TU size pattern 2 (step S105).

Transform/quantization processing and inverse transform/inverse quantization processing are repeatedly executed similarly for each of N types of TU size patterns (steps S106 to S107). After processing is executed for each of the N types of the TU size patterns, the transform processing unit 3000 ends transform/quantization processing.

Note that transform/quantization processing and inverse transform/inverse quantization processing for each of N types of TU size patterns may be sequentially executed as illustrated in FIG. 4 or may be executed in parallel.

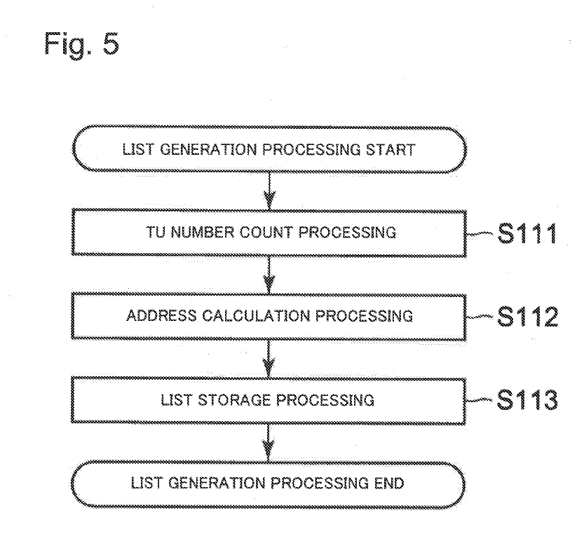

An operation of the list generation unit 3300 of the present example embodiment will be described below with reference to FIG. 5. FIG. 5 is a flowchart illustrating list generation processing executed by the list generation unit 3300. In other words, processing of steps S111 to S113 illustrated in FIG. 5 is equivalent to the processing of step S101 illustrated in FIG. 4. The list generation unit 3300 accepts input of TU size information and CBFs, executes list generation processing, and outputs the above-described list for each of TU sizes.

The count unit 3310 counts, using the input TU size information and CBFs, TUs to be executed in transform/quantization processing existing in an allocated area for each TU size (step S111). Note that, as described above, the area is an area of a divided residual image allocated in such a way that list generation processing is executed in parallel. The processing of step S111 is processing independent for each area, and therefore the count unit 3310 can efficiently execute parallel processing.

Then, the address calculation unit 3320 accepts input of TU number information generated in the count unit 3310 and calculates an address of a list in which execution TU information of TUs to be executed in transform/quantization processing is written (step S112). The address calculation unit 3320 calculates an address for each TU size.

A calculation method for an address includes Parallel Scan described in, for example, NPL 4. Parallel Scan is a method for efficiently determining a partial sum by parallel processing and a method used in Stream Compaction.

Stream Compaction is processing of outputting, for input data in which pieces of significant data discontinuously exist, only significant data by being packed. In other words, Stream Compaction is similar to processing of the list generation unit 3300 that packs coordinate data regarding TUs to be executed and outputs the packed data. Note that specific contents of Parallel Scan and Stream Compaction are described in NPL 4.

In the present example, the address calculation unit 3320 calculates a partial sum of the number of TUs by using Parallel Scan. Therefore, the address calculation unit 3320 can efficiently calculate, by parallel processing, addresses in which lists of a format where only pieces of execution TU information to be executed are packed are generated.

Then, the list storage unit 3330 accepts input of information indicating the addresses of the lists generated in the address calculation unit 3320 and writes pieces of execution TU information in the addresses, respectively (step S113). The processing of step S113 is processing independent for each execution area, and therefore the list storage unit 3330 can efficiently execute parallel processing. After writing all pieces of execution TU information, the list storage unit 3330 outputs an execution TU list. After outputting the execution TU list, the list generation unit 3300 ends list generation processing.

### [Advantageous Effect]

Next, an advantageous effect according to the present example embodiment will be described. The list generation unit 3300 of the present example embodiment generates a list storing pieces of data of the same TU size for each TU size. Using the generated list, the transform/quantization units 3101 to 310N and the inverse transform/inverse quantization units 3201 to 320N can collectively execute processing for a plurality of TUs of the same size without using an operation such as gather and scatter for image data. In other words, transform/quantization processing and inverse transform/inverse quantization processing are efficiently executed in parallel.

Further, in a list generated by the list generation unit 3300, only pieces of position information of TUs are listed. Therefore, a temporary area necessary for generating a list is smaller than a temporary area, necessary for the gather unit 3900 illustrated in FIG. 28, capable of storing at least the entire image.

Further, the list generation unit 3300 of the present example embodiment can efficiently execute list generation processing in parallel, for each area of a divided image and therefore can be realized by a many-core architecture such as a GPU. When the list generation unit 3300 is realized, a GPU can efficiently execute list generation processing in parallel. In other words, the entire transform processing unit 3000 including the list generation unit 3300 can be realized by a many-core architecture such as a GPU, and therefore encoding processing is efficiently executed.

In other words, the above-described second problem that a large amount of communication is generated between a CPU and a GPU is solved. The video image encoding device of the present example embodiment can execute video image encoding without decreasing parallel processing efficiency, and therefore high-speed video image encoding processing can be realized.

### Second Example Embodiment

### [Configuration]

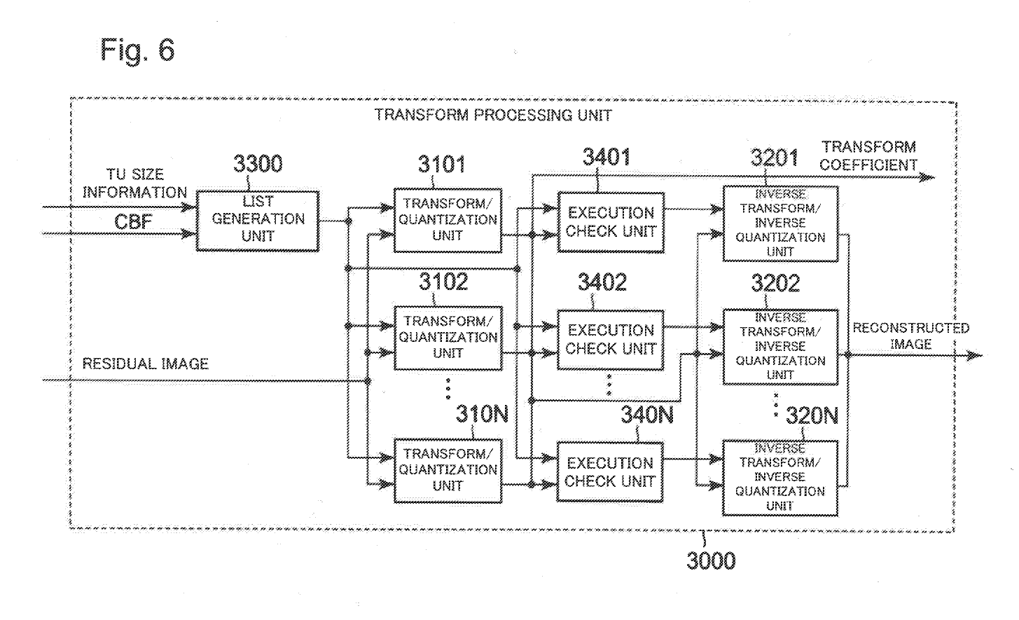

Next, a second example embodiment of the present invention will be described with reference to the drawings. FIG. 6 is a block diagram illustrating a configuration example of a transform processing unit 3000 according to the second example embodiment of the present invention. Note that, while TU size patterns of H.265 are four types of 4×4, 8×8, 16×16, and 32×32, it is assumed that TU size patterns of the present example embodiment are N types.

As illustrated in FIG. 6, the transform processing unit 3000 of a video image encoding device of the present example embodiment includes execution check units 3401 to 340N, differently from the transform processing unit 3000 illustrated in FIG. 1. A configuration of the transform processing unit 3000 illustrated in FIG. 6 is similar to the configuration of the transform processing unit 3000 illustrated in FIG. 1 except the execution check units 3401 to 340N.

The transform processing unit 3000 of the present example embodiment is characterized in that when all transform coefficients output from transform/quantization units 3101 to 310N are “0”, inverse transform/inverse quantization processing is not executed for the transform coefficients. The reason why the transform processing unit 3000 does not execute inverse transform/inverse quantization processing is that even when inverse transform/inverse quantization processing is executed for all transform coefficients of “0”, all results are only obtained as “0” and a cost necessary for inverse transform/inverse quantization processing is wasted.

The execution check unit 3401 of the present example embodiment includes a function of confirming whether a non-zero coefficient is included in transform coefficients regarding TUs of a corresponding TU size. The execution check unit 3401 accepts transform coefficients output from the transform quantization unit 3101 and an execution TU list output from the list generation unit 3300 and scans the input transform coefficients.

As the result of the scanning, when all the transform coefficients are “0”, the execution check unit 3401 assigns flag information indicating a TU not to be executed in inverse transform/inverse quantization processing to data (e.g. a list 1 or a list 2) in an execution TU list of TUs corresponding to the scanned transform coefficients. A function included in each of the execution check units 3402 to 340N is similar to the function included in the execution check unit 3401.

### [Operation]

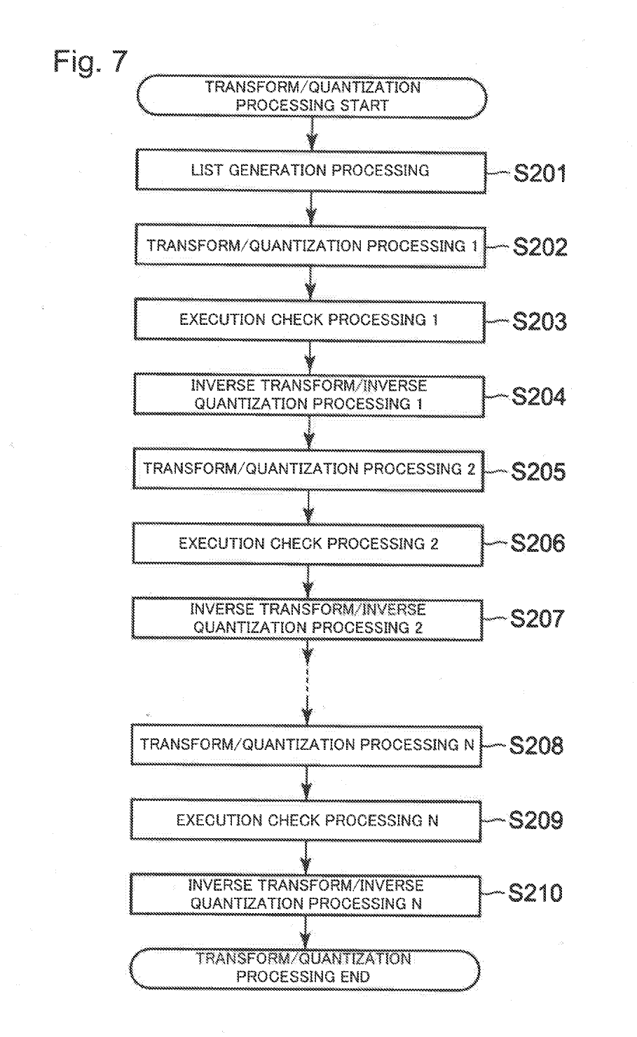

An operation of the transform processing unit 3000 of the present example embodiment will be described below with reference to FIG. 7. FIG. 7 is a flowchart illustrating transform/quantization processing executed by the transform processing unit 3000 of the second example embodiment.

Processing of step S201 is similar to the processing of step S101 illustrated in FIG. 4. In other words, the list generation unit 3300 generates, based on input CBFs and TU size information, an execution TU list in which pieces of execution TU information of TUs in an allocated area are listed for each TU size.

The transform/quantization unit 3101 accepts input of a list 1 regarding a TU size pattern 1 in the execution TU list generated by the list generation unit 3300 and a residual image and collectively executes transform/quantization processing for only TUs regarding the TU size pattern 1. Then, the transform/quantization unit 3101 inputs transform coefficients as the execution result to the execution check unit 3401 (step S202).

Then, the execution check unit 3401 scans, based on the input execution TU list and transform coefficients, the transform coefficients in order to confirm whether a non-zero coefficient is included in transform coefficients of TUs corresponding to the execution TU information described in the list 1.

When a non-zero coefficient is not included in the transform coefficients and all the transform coefficients are “0”, the execution check unit 3401 assigns flag information indicating a TU not to be executed in inverse transform/inverse quantization processing to data (i.e. the list 1) in the list of TUs corresponding to the scanned transform coefficients. When at least one non-zero coefficient is included in the transform coefficients, the execution check unit 3401 does not execute processing for the list 1.

Then, the execution check unit 3401 inputs transform coefficients and an execution TU list to the inverse transform/inverse quantization unit 3201 (step S203).

Then, the inverse transform/inverse quantization unit 3201 refers to the list 1 of the execution TU list input from the execution check unit 3401. When flag information is assigned to the list 1 referred to, the inverse transform/inverse quantization unit 3201 does not execute inverse transform/inverse quantization processing for the input transform coefficients.

When flag information is not assigned to the list 1 referred to, the inverse transform/inverse quantization unit 3201 executes inverse transform/inverse quantization processing for the input transform coefficients. The inverse transform/inverse quantization unit 3201 collectively executes inverse transform/inverse quantization processing for only transform coefficients regarding the TU size pattern 1 (step S204).

Transform/quantization processing, execution check processing, and inverse transform/inverse quantization processing are repeatedly executed similarly for each of N types of TU size patterns (steps S202 to S210). After processing is executed for each of the N types of the TU size patterns, the transform processing unit 3000 ends transform/quantization processing.

Note that transform/quantization processing, execution check processing, and inverse transform/inverse quantization processing for each of N types of TU size patterns may be sequentially executed as illustrated in FIG. 7 or may be executed in parallel.

### [Advantageous Effect]

Next, an advantageous effect according to the present example embodiment will be described. The execution check units 3401 to 340N of the present example embodiment determine whether an input transform coefficient is an execution target for inverse transform/inverse quantization processing. The execution check units 3401 to 340N are added, and thereby an amount of calculation regarding inverse transform/inverse quantization processing is reduced when there is a transform coefficient unneeded to be executed in inverse transform/inverse quantization processing.

### Third Example Embodiment

### [Configuration]

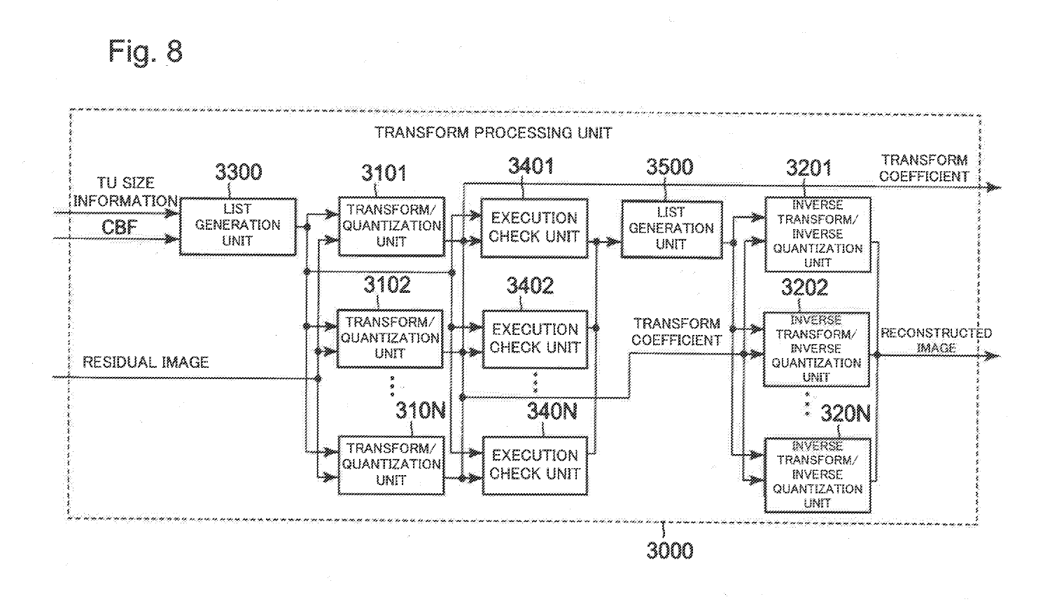

Next, a third example embodiment of the present invention will be described with reference to the drawings. FIG. 8 is a block diagram illustrating a configuration example of a transform processing unit 3000 according to the third example embodiment of the present invention. Note that, while TU size patterns of H.265 are four types of 4×4, 8×8, 16×16, and 32×32, it is assumed that TU size patterns of the present example embodiment are N types.

As illustrated in FIG. 8, the transform processing unit 3000 of a video image encoding device of the present example embodiment includes a list generation unit 3500 in a subsequent stage of execution check units 3401 to 340N, differently from the transform processing unit 3000 illustrated in FIG. 6. A configuration of the transform processing unit 3000 illustrated in FIG. 8 is similar to the configuration of the transform processing unit 3000 illustrated in FIG. 6 except the list generation unit 3500.

The transform processing unit 3000 of the present example embodiment is characterized in that before inverse transform/inverse quantization processing is executed using execution TU information including flag information indicating that a transform coefficient is an execution target of inverse transform/inverse quantization processing, an execution TU list is generated again.

A function included in the list generation unit 3500 of the present example embodiment is similar to the function included in the list generation unit 3300. Further, a configuration of the list generation unit 3500 is similar to the configuration of the list generation unit 3300.

In other words, the list generation unit 3500 includes a function of generating, using TU size information as input, an execution TU list in which pieces of execution TU information of TUs in an allocated area are listed for each TU size. Note that the list generation unit 3500 can execute generation processing in parallel for respective areas.

### [Operation]

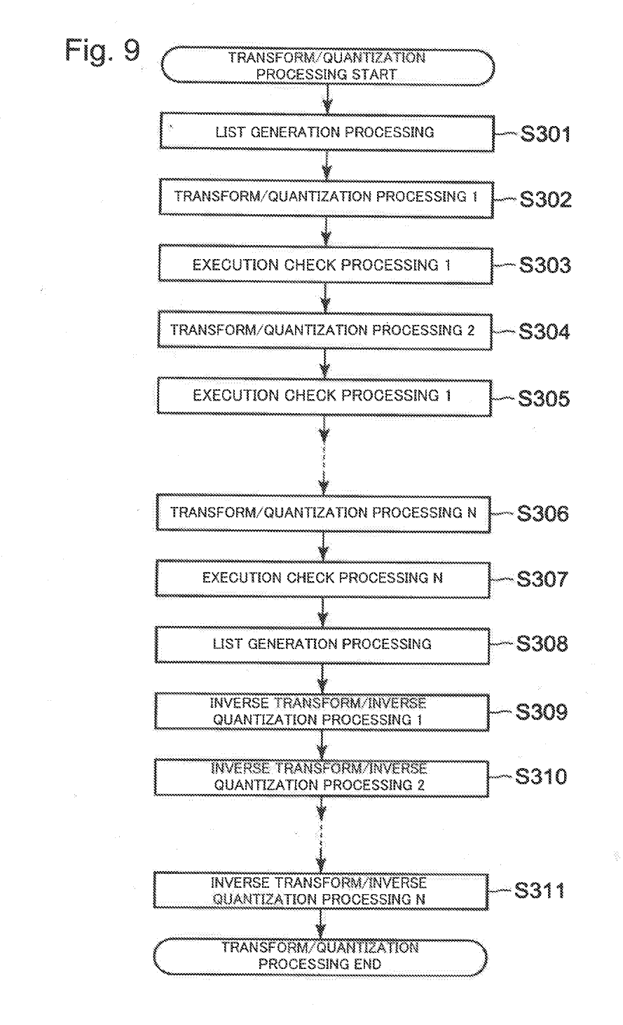

An operation of the transform processing unit 3000 of the present example embodiment will be described below with reference to FIG. 9. FIG. 9 is a flowchart illustrating transform/quantization processing executed by the transform processing unit 3000 of the third example embodiment.

Processing of steps S301 to S302 is similar to the processing of steps S201 to 202 illustrated in FIG. 7. In other words, the list generation unit 3300 generates, based on input CBFs and TU size information, an execution TU list in which pieces of execution TU information of TUs in an allocated area are listed for each TU size. Further, a transform/quantization unit 3101 accepts input of a list 1 regarding a TU size pattern 1 in the execution TU list generated by the list generation unit 3300 and a residual image and collectively executes transform/quantization processing for only TUs regarding the TU size pattern 1.

The execution check unit 3401 scans, based on the input execution TU list and transform coefficients, the transform coefficients in order to confirm whether a non-zero coefficient is included in transform coefficients of TUs corresponding to the execution TU information described in the list 1. When a non-zero coefficient is included in the scanned transform coefficients, the execution check unit 3401 assigns flag information indicating a TU to be executed in inverse transform/inverse quantization processing to execution TU information in the list 1 of a TU corresponding to the non-zero coefficient (step S303).

Then, the execution check unit 3401 inputs an execution TU list assigned with the flag information indicating a TU to be executed in inverse transform/inverse quantization processing to the list generation unit 3500. Transform/quantization processing and execution check processing are repeatedly executed similarly for each of N types of TU size patterns (steps S302 to S307).

After all transform/quantization processing and execution check processing are completed, the list generation unit 3500 generates an execution TU list for inverse transform/inverse quantization processing in which pieces of execution TU information of TUs in the allocated area are listed for each TU size.

The list generation unit 3500 generates an execution TU list for inverse transform/inverse quantization processing, based on input execution TU information assigned with flag information indicating a TU to be executed in inverse transform/inverse quantization processing (step S308).

In an execution TU list generated by the list generation unit 3500, execution TU information of a TU not to be executed in inverse transform/inverse quantization is deleted, compared with an execution TU list generated by the list generation unit 3300. In other words, an execution TU list of a format where pieces of execution TU information are included by being further packed is obtained.

Then, the inverse transform/inverse quantization unit 3201 accepts input of a list 1 regarding a TU size pattern 1 in the execution TU list generated by the list generation unit 3500 and transform coefficients output by the transform/quantization unit 3101 and collectively executes inverse transform/inverse quantization processing for only transform coefficients regarding the TU size pattern 1 (step S309).

The list 1 includes only execution TU information regarding a TU to be executed in inverse transform/inverse quantization processing. Therefore, the inverse transform/inverse quantization 3201 may execute, by referring to the list 1, inverse transform/inverse quantization processing for only a transform coefficient corresponding to a TU to be executed.

Inverse transform/inverse quantization processing is repeatedly executed similarly for each of N types of TU size patterns (steps S309 to S311). After processing is executed for each of the N types of the TU size patterns, the transform processing unit 3000 ends transform/quantization processing.

Note that transform/quantization processing, execution check processing, and inverse transform/inverse quantization processing for each of N types of TU size patterns may be sequentially executed as illustrated in FIG. 9 or may be executed in parallel.

### [Advantageous Effect]

Next, an advantageous effect according to the present example embodiment will be described. The list generation unit 3500 of the present example embodiment regenerates an execution TU list before inverse transform/inverse quantization processing is executed. Therefore, the inverse transform/inverse quantization units 3201 to 320N can delete a thread necessary for inverse transform/inverse quantization. The reason is as follows.

One warp is allocated with transform coefficients of a plurality of TUs. When an execution TU list is not regenerated, TUs corresponding to transform coefficients to be processed by one warp include a TU to be executed in inverse transform/inverse quantization processing and a TU not to be executed, and therefore inverse transform/inverse quantization processing is not efficiently executed.

On the other hands, when an execution TU list is regenerated, execution TU information regarding a TU not to be executed does not exist in a list. Therefore, in this case, the inverse transform/inverse quantization units 3201 to 320N may operate only a thread necessary for executing inverse transform/inverse quantization processing for a transform coefficient of a TU to be executed.

### Fourth Example Embodiment

### [Configuration]

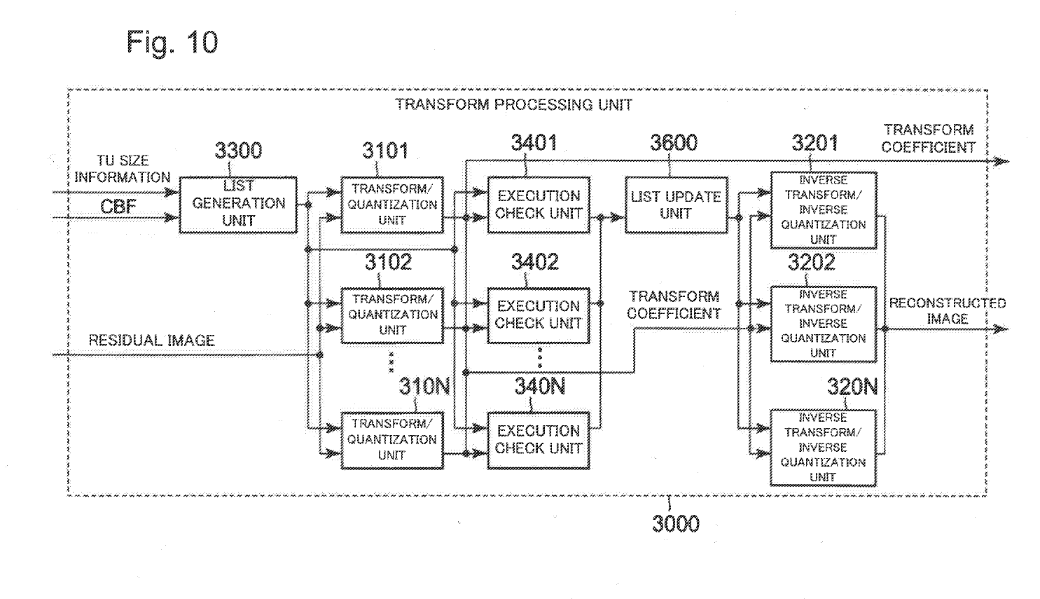

Next, a fourth example embodiment of the present invention will be described with reference to the drawings. FIG. 10 is a block diagram illustrating a configuration example of a transform processing unit 3000 according to the fourth example embodiment of the present invention. Note that, while TU size patterns of H.265 are four types of 4×4, 8×8, 16×16, and 32×32, it is assumed that TU size patterns of the present example embodiment are N types.

As illustrated in FIG. 10, the transform processing unit 3000 of a video image encoding device of the present example embodiment includes a list update unit 3600 instead of the list generation unit 3500, differently from the transform processing unit 3000 illustrated in FIG. 8. A configuration of the transform processing unit 3000 illustrated in FIG. 10 is similar to the configuration of the transform processing unit 3000 illustrated in FIG. 8 except the list update unit 3600.

The list update unit 3600 of the present example embodiment is characterized by simply updating an execution TU list generated by a list generation unit 3300. The list update unit 3600 updates an execution TU list before inverse transform/inverse quantization processing is executed, using TU size information including flag information indicating a TU to be executed in inverse transform/inverse quantization processing.

A function included in the list update unit 3600 of the present example embodiment is different from the function included in the list generation unit 3300. The list update unit 3600 rearranges pieces of execution TU information in a list for each TU size in any area, based on flag information indicating a TU to be executed in inverse transform/inverse quantization processing, in such a way that pieces of execution TU information regarding TUs to be executed are collected.

Note that the list update unit 3600 can execute update processing in parallel for respective areas. The transform processing unit 3000 of the present example embodiment may include list update units 3600 correspondingly to the number of divided areas.

As described above, an SIMT architecture such as a GPU fetches an instruction for a warp. Note that the fetch is processing of reading, in a first stage where a microprocessor executes an instruction, an instruction code from a memory and transferring the read code to a register inside the processor. In other words, all threads in a warp need to execute the same operation.

The list update unit 3600 of the present example embodiment rearranges pieces of execution TU information in a list of any area in such a way as to collectively dispose pieces of execution TU information regarding TUs to be executed, in such a way that all threads in a warp execute the same operation. When the list update unit 3600 does not update a list, upon inclusion of a TU not to be executed in TUs allocated to a warp, a thread stalled in the warp is generated.

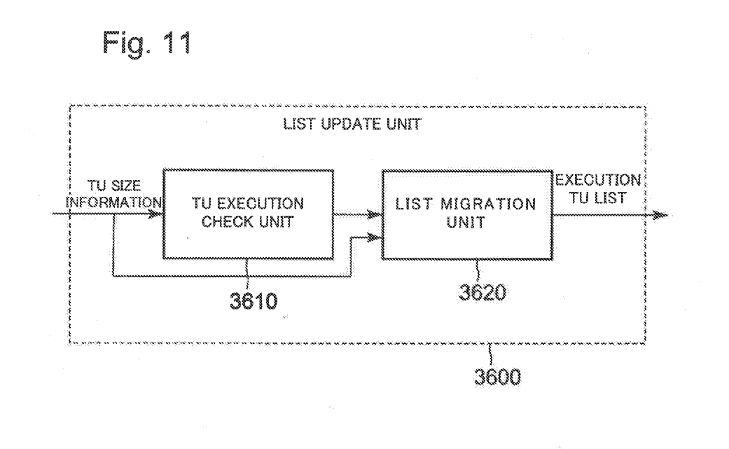

FIG. 11 is a block diagram illustrating a configuration example of the list update unit 3600. As illustrated in FIG. 11, the list update unit 3600 includes a TU execution check unit 3610 and a list migration unit 3620.

The TU execution check unit 3610 includes a function of searching execution TU information regarding a TU not to be executed in inverse transform/inverse quantization. The TU execution check unit 3610 searches execution TU information regarding a TU not to be executed in an execution TU list including flag information indicating TUs to be executed in inverse transform/inverse quantization.

The list migration unit 3620 includes a function of changing a position in a list of execution TU information regarding a TU not to be executed in an allocated area. In other words, the list migration unit 3620 migrates execution TU information regarding a TU not to be executed to another position in a list.

An SIMT architecture such as a GPU can efficiently execute processing when processing of threads in a warp is uniform. The list migration unit 3620 rearranges pieces of execution TU information in a list in such a way that processing of threads in a warp is uniform.

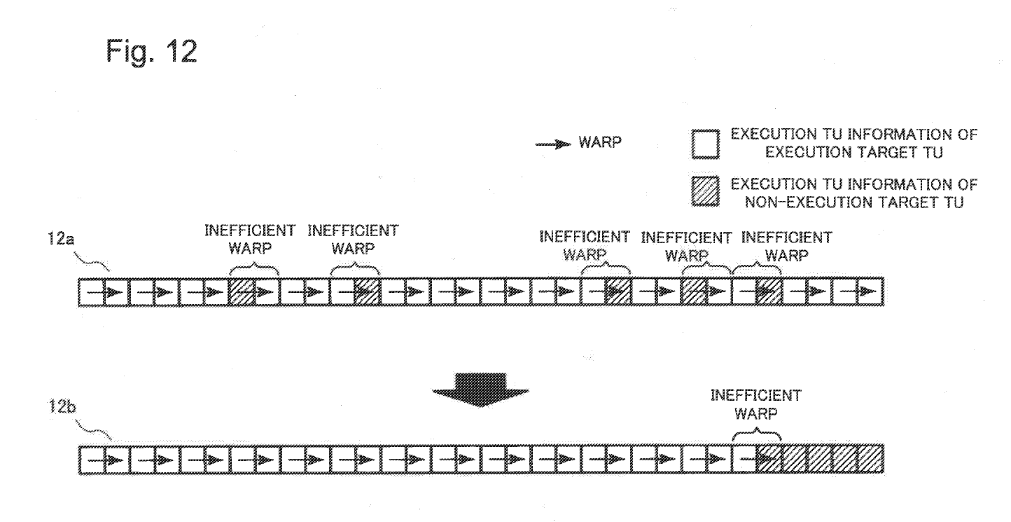

An example of migration processing executed by the list migration unit 3620 is illustrated in FIG. 12. FIG. 12 is an illustrative diagram illustrating an example of migration processing of execution TU information in a list executed by the list migration unit 3620. In FIG. 12, a rectangle that is not hatched indicates execution TU information of a TU to be executed. Further, a rectangle that is hatched indicates execution TU information of a TU not to be executed. Further, an arrow indicates a warp. A rectangle including an arrow indicates execution TU information to be processed by a warp indicated by an arrow.

In FIG. 12, a list 12a illustrates an example of execution TU information before migration. In the list 12a, the execution TU information includes execution TU information of a TU to be executed and execution TU information not to be executed. Further, in the list 12a, a TU to be executed and a TU not to be executed are mixed in a block to be processed, and therefore a warp that is forced to execute inefficient processing is indicated as an “inefficient warp”.

The list migration unit 3620 sequentially sorts, based on execution TU information included in the list 12a, the entire execution TU information in a list of any area in which, for example, execution TU information of a TU to be executed is designated as “1” and execution TU information of a TU not to be executed is designated as “0” in a list. Further, the list migration unit 3620 may sort the entire execution TU information in a list by using a parallel sorting algorithm.

A list 12b of FIG. 12 illustrates an example of execution TU information after migration. In the list 12b, pieces of execution TU information after sorting are collected respectively as execution TU information to be executed and execution TU information not to be executed. In other words, the list migration unit 3620 can reduce an “inefficient warp” that is forced to execute inefficient processing since a TU to be executed and a TU not to be executed are mixed in a block to be processed.

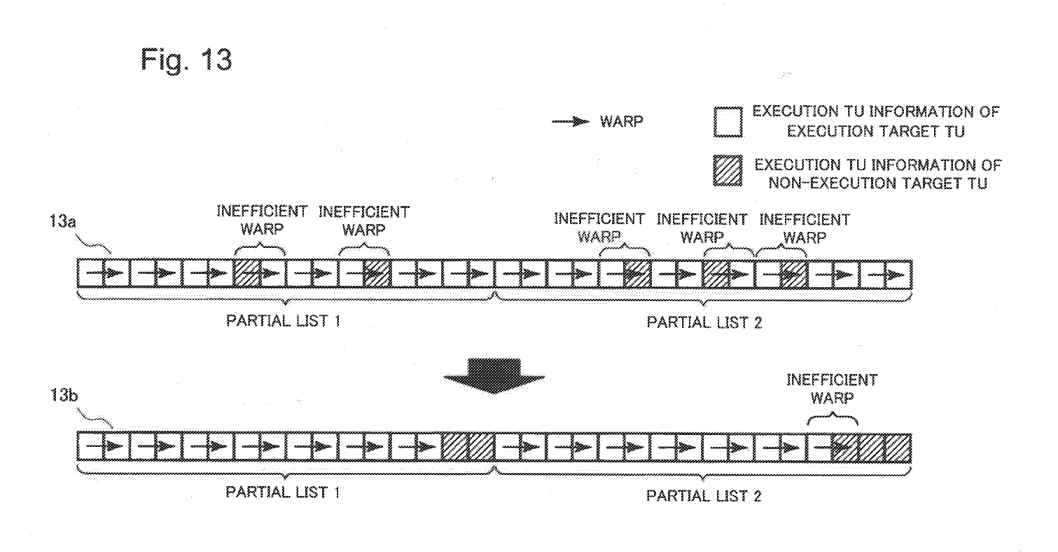

FIG. 13 is an illustrative diagram illustrating another example of migration processing of execution TU information in a list executed by the list migration unit 3620.

In FIG. 13, a list 13a illustrates another example of execution TU information before migration. The list 13a is divided into a partial list 1 and a partial list 2. In the partial list 1 and the partial list 2, there is a plurality of “inefficient warps” in which a TU to be executed and a TU not to be executed are mixed in a block to be processed.

A list 13b of FIG. 13 illustrates another example of execution TU information after migration. In the example illustrated in the list 13b, the list migration unit 3620 sorts pieces of execution TU information included in respective partial lists independently of each other. Sorting is executed for each partial list, and thereby an execution TU list is simply updated using an amount of calculation smaller than in the example illustrated in FIG. 12.

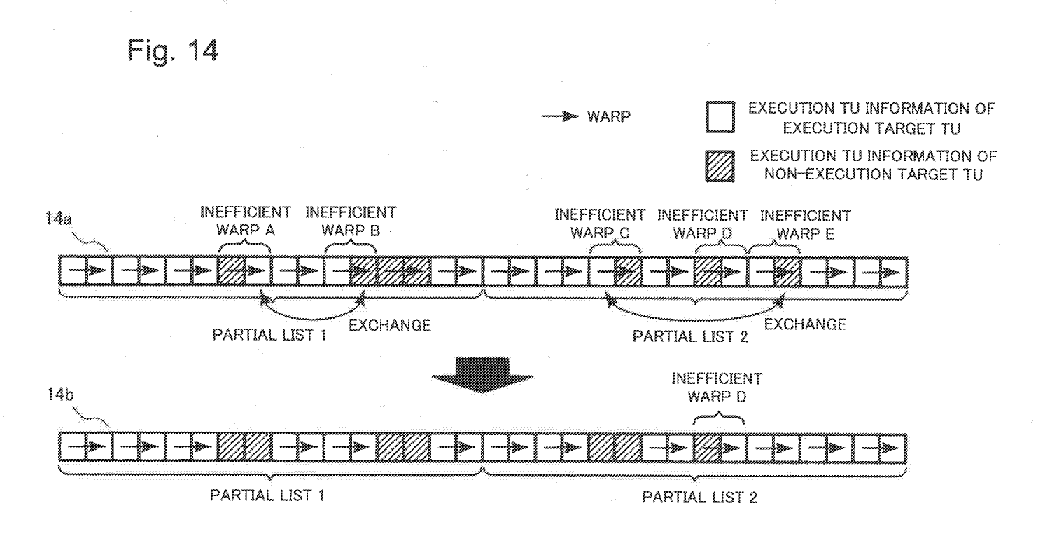

FIG. 14 is an illustrative diagram illustrating still another example of migration processing of execution TU information in a list executed by the list migration unit 3620.

In FIG. 14, a list 14a illustrates still another example of execution TU information before migration. The list 14a is divided into a partial list 1 and a partial list 2. In the partial list 1 and the partial list 2, there are warps A to E that are “inefficient warps” in which a TU to be executed and a TU not to be executed are mixed in a block to be processed.

In the example illustrated in the list 14a, the list migration unit 3620 exchanges pieces of execution TU information of TUs processed by respective warps. When attention is focused on a point that when threads in a warp execute an equal operation, pieces of execution TU information are exchanged in such a way that a block to be processed by threads in a warp includes only TUs to be executed, and thereby processing is efficiently executed.

The list migration unit 3620 exchanges, for example, execution TU information of a TU to be executed that is processed by a warp A and execution TU information of a TU not to be executed that is processed by a warp B. Further, the list migration unit 3620 exchanges execution TU information of a TU to be executed that is processed by a warp C and execution TU information of a TU not to be executed that is processed by a warp E.

A list 14b of FIG. 14 illustrates still another example of execution TU information after migration. In the list 14b, pieces of execution TU information of TUs not to be executed have been collected, and therefore warps corresponding to the warp A and the warp C are deleted. In other words, pieces of execution TU information are exchanged, and thereby inverse transform/inverse quantization processing is executed using fewer warps.

### [Operation]

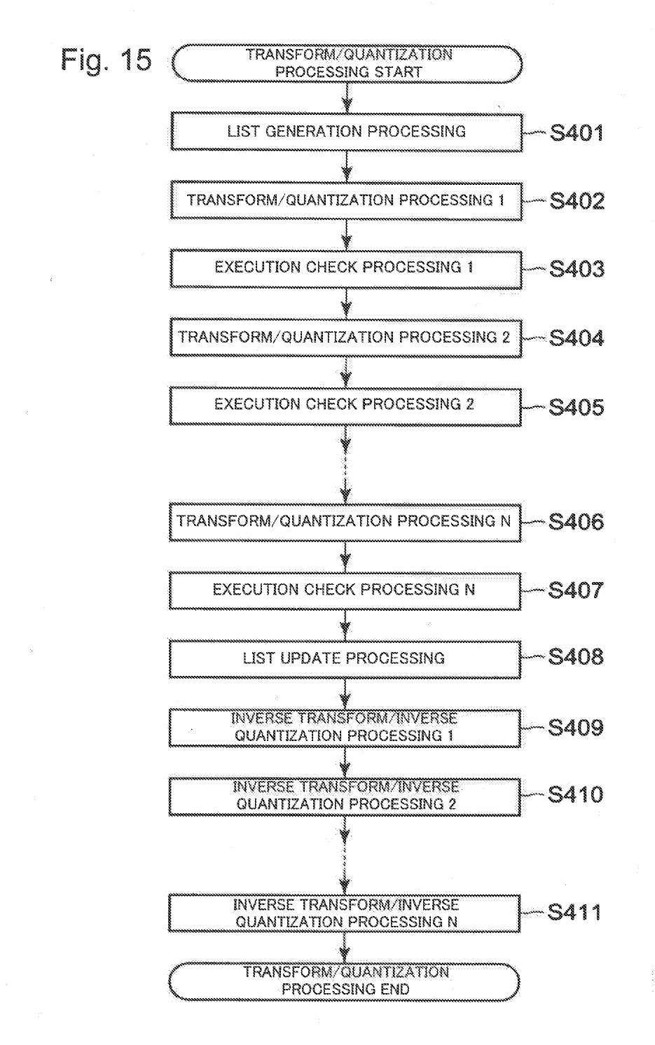

An operation of the transform processing unit 3000 of the present example embodiment will be described below with reference to FIG. 15. FIG. 15 is a flowchart illustrating transform/quantization processing executed by the transform processing unit 3000 of the fourth example embodiment.

Processing of steps S401 to S407 is similar to the processing of steps S301 to S307 illustrated in FIG. 9.

The list update unit 3600 updates a list for each TU size, based on input execution TU information assigned with flag information indicating a TU to be executed in inverse transform/inverse quantization, in such a way as to collectively dispose pieces of execution TU information regarding TUs to be executed (step S408).

Then, the inverse transform/inverse quantization unit 3201 accepts input of a list 1 regarding a TU size pattern 1 in the execution TU list updated in the list update unit 3600 and transform coefficients output by a transform/quantization unit 3101 and collectively executes inverse transform/inverse quantization processing for only transform coefficients regarding the TU size pattern 1 (step S409).

In the list 1, pieces of execution TU information regarding TUs to be executed in inverse transform/inverse quantization processing are collectively disposed. Therefore, the inverse transform/inverse quantization unit 3201 may execute inverse transform/inverse quantization processing for only a transform coefficient corresponding to a TU to be executed by referring to the list 1.

Inverse transform/inverse quantization processing is repeatedly executed similarly for each of N types of TU size patterns (steps S409 to S411). After processing is executed for each of the N types of the TU size patterns, the transform processing unit 3000 ends transform/quantization processing.

Note that transform/quantization processing, execution check processing, and inverse transform/inverse quantization processing for each of N types of TU size patterns may be sequentially executed as illustrated in FIG. 15 or may be executed in parallel.

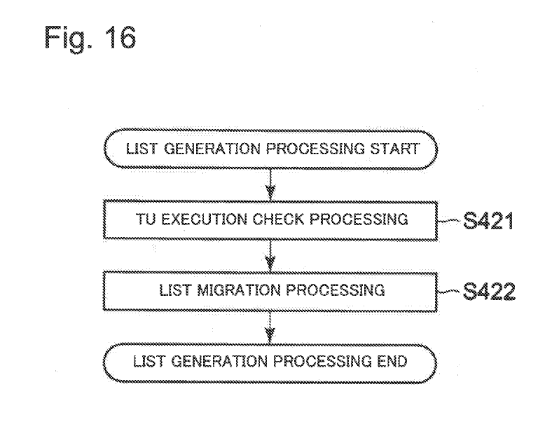

An operation of the list update unit 3600 of the present example embodiment will be described below with reference to FIG. 16. FIG. 16 is a flowchart illustrating list update processing executed by the list update unit 3600. In other words, processing of steps S421 to S422 illustrated in FIG. 16 is equivalent to the processing of step S408 illustrated in FIG. 15.

The TU execution check unit 3610 searches pieces of execution TU information regarding TUs not to be executed, based on TU size information assigned with flag information indicating a TU to be executed in inverse transform/inverse quantization processing, to an input execution TU list (step S421).

Then, the list migration unit 3620 migrates execution TU information in such a way that pieces of execution TU information in the list regarding TUs not to be executed searched by the TU execution check unit 3610 are collected (step S422). After migrating the execution TU information, the list update unit 3600 ends list update processing.

### [Advantageous Effect]

Next, an advantageous effect according to the present example embodiment will be described. The list update unit 3600 of the present example embodiment simply updates an execution TU list before inverse transform/inverse quantization processing is executed. An amount of calculation regarding list update processing of the present example embodiment is smaller than an amount of calculation upon regenerating an execution TU list by calculating a partial sum, for example, as in the third example embodiment. Therefore, the transform processing unit 3000 of the present example embodiment can reduce threads necessary for inverse transform/inverse quantization processing by using a smaller amount of calculation.

### Fifth Example Embodiment

### [Configuration]

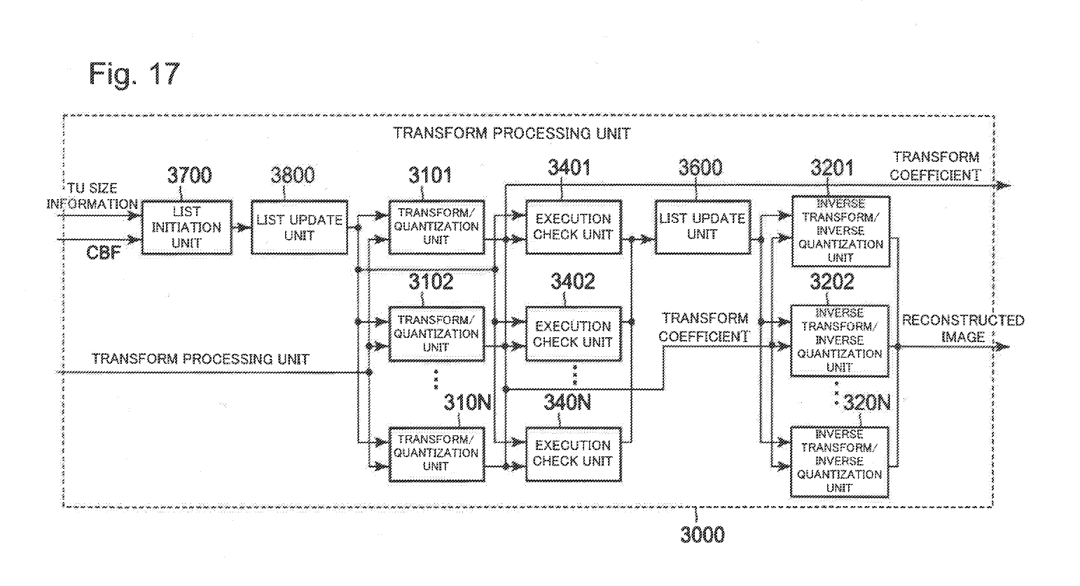

Next, a fifth example embodiment of the present invention will be described with reference to the drawings. FIG. 17 is a block diagram illustrating a configuration example of a transform processing unit 3000 according to the fifth example embodiment of the present invention. Note that, while TU size patterns of H.265 are four types of 4×4, 8×8, 16×16, and 32×32, it is assumed that TU size patterns of the present example embodiment are N types.

As illustrated in FIG. 17, the transform processing unit 3000 of a video image encoding device of the present example embodiment includes a list initiation unit 3700 and a list update unit 3800 instead of the list generation unit 3300, differently from the transform processing unit 3000 illustrated in FIG. 10. A configuration of the transform processing unit 3000 illustrated in FIG. 17 is similar to the configuration of the transform processing unit 3000 illustrated in FIG. 10 except the list initiation unit 3700 and the list update unit 3800.

The transform processing unit 3000 of the present example embodiment is characterized by simply generating an execution TU list by using TU size information.

The list initiation unit 3700 of the present example embodiment includes a function of generating a list in which pieces of execution TU information of TUs in an allocated area are listed for each TU size, based on input TU size information.

The list generation unit 3300 of each of the first example embodiment to the fourth example embodiment generates execution TU information correspondingly to the number of TUs to be executed in transform/quantization processing. On the other hand, the list initiation unit 3700 of the present example embodiment generates execution TU information (hereinafter, referred to also as an entry) correspondingly to the number of TUs theoretically existing in a screen.

Note that the list initiation unit 3700 can execute in parallel initiation processing for each area. The transform processing unit 3000 of the present example embodiment may include list initiation units 3700 correspondingly to the number of divided areas.

A configuration of the list update unit 3800 is similar to the configuration of the list update unit 3600 illustrated in FIG. 11. The list update unit 3800 includes a function of updating a format of a list generated by the list initiation unit 3700 of a preceding stage to a format where threads in a warp that realize transform/quantization units 3101 to 310N easily execute transform/quantization processing in parallel.

Note that the list update unit 3800 can execute in parallel update processing for each area. The transform processing unit 3000 of the present example embodiment may include list update units 3800 correspondingly to the number of divided areas.

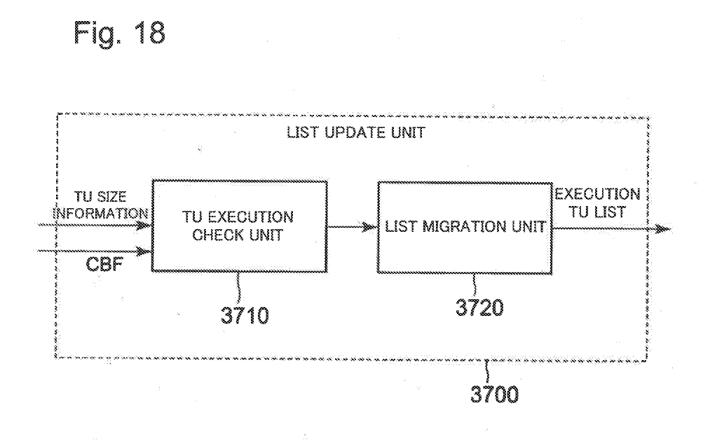

FIG. 18 is a block diagram illustrating a configuration example of the list initiation unit 3700. As illustrated in FIG. 18, the list initiation unit 3700 includes a TU execution check unit 3710 and an entry generation unit 3720.

The TU execution check unit 3710 includes a function of searching a TU not to be executed in transform/quantization processing. The TU execution check unit 3710 scans all TUs in an allocated area by using a CBF and TU size information indicating a TU not to be executed in transform/quantization processing and searches TUs not to be executed correspondingly to the number of divided areas.

The entry generation unit 3720 includes a function of generating an entry of an execution TU list of an allocated area. The entry generation unit 3720 discriminates a TU to be executed and a TU not to be executed with respect to all TUs existing in an allocated area and generates an entry for each execution TU list. The entry generation unit 3720 stores the generated entry in an execution TU list.

### [Operation]

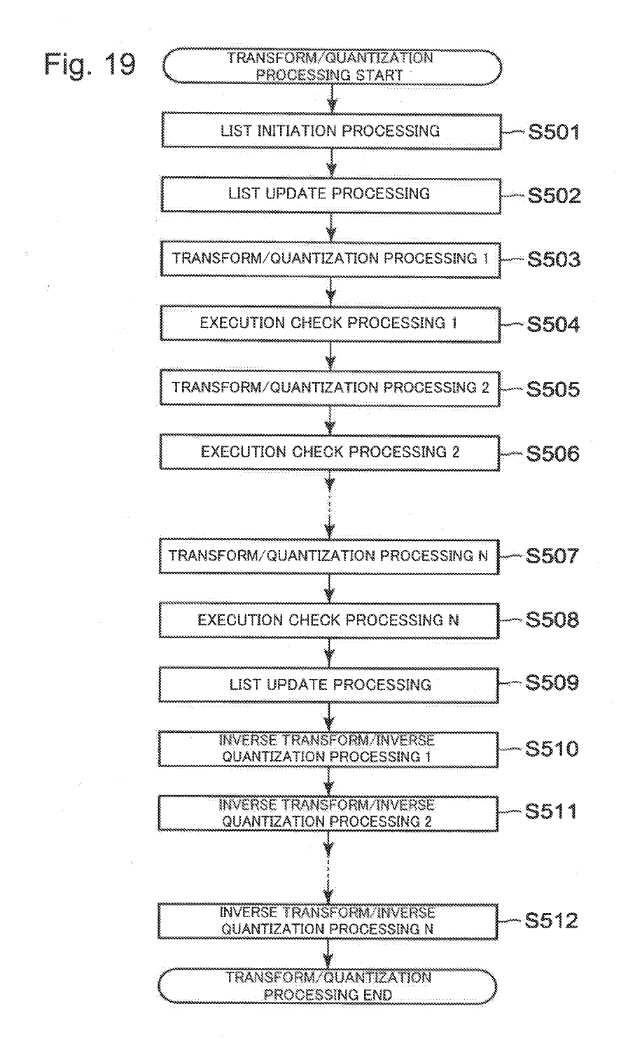

An operation of the transform processing unit 3000 of the present example embodiment will be described below with reference to FIG. 19. FIG. 19 is a flowchart illustrating transform/quantization processing executed by the transform processing unit 3000 of the fifth example embodiment.

The list initiation unit 3700 accepts input of CBFs and TU size information and generates an execution TU list in which pieces of execution TU information of TUs in an allocated area are listed for each TU size (step S501).

Then, the list update unit 3800 updates a list in which pieces of execution TU information, assigned with input flag information indicating a TU not to be executed in transform/quantization processing, are listed for each TU size, in such a way as to collectively dispose pieces of execution TU information regarding TUs to be executed (step S502).

Processing of steps S503 to S512 is similar to the processing of steps S402 to S411 illustrated in FIG. 15. After processing is executed for each of N types of TU size patterns, the transform processing unit 3000 ends transform/quantization processing.

Note that transform/quantization processing, execution check processing, and inverse transform/inverse quantization processing for each of N types of TU size patterns may be sequentially executed as illustrated in FIG. 19 or may be executed in parallel.

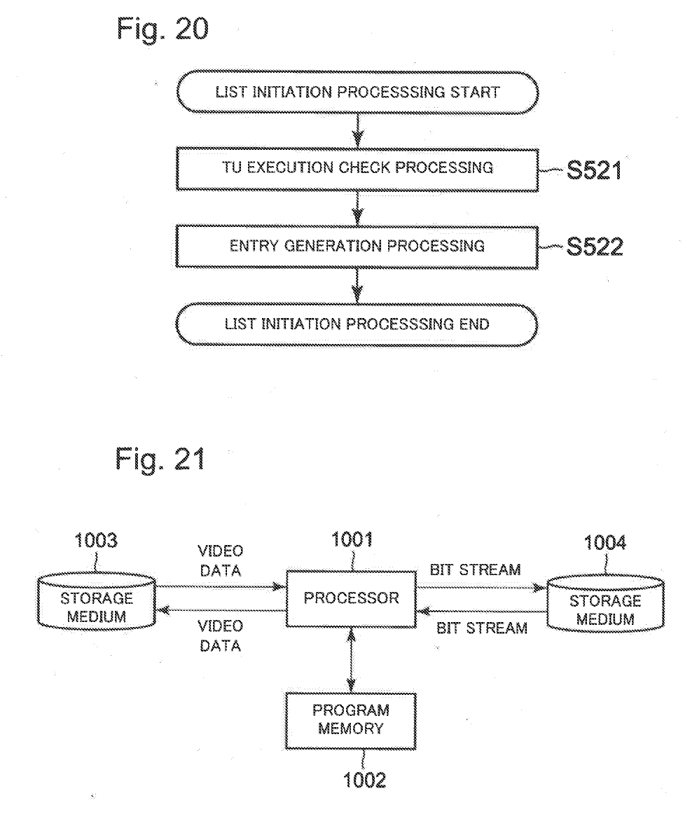

An operation of the list initiation unit 3700 of the present example embodiment will be described below with reference to FIG. 20. FIG. 20 is a flowchart illustrating list initiation processing executed by the list initiation unit 3700. In other words, processing of steps S521 to S522 illustrated in FIG. 20 is equivalent to the processing of step S501 illustrated in FIG. 19.

In order to execute initiation processing in parallel, the list initiation unit 3700 is allocated with any image area. The list initiation unit 3700 accepts input of TU size information and CBFs.

The TU execution check unit 3710 counts TUs to be executed and TUs not to be executed existing in the allocated area by using the input TU size information for each TU size, respectively (step S521). The TU execution check unit 3710 inputs the acquired number of TUs to the entry generation unit 3720.

Then, the entry generation unit 3720 generates respective entries for an execution TU list of the allocated area, based on the number of TUs acquired by the TU execution check unit 3710 (step S522). The entry generation unit 3720 distinguishes TUs to be executed from TUs not to be executed and generates respective entries. The entry generation unit 3720 stores the generated entries in the execution TU list. After storing all entries, the list initiation unit 3700 ends list initiation processing.

### [Advantageous Effect]

Next, an advantageous effect according to the present example embodiment will be described. The list initiation unit 3700 of the present example embodiment simply generates an execution TU list, and the list update unit 3800 updates the execution TU list. An amount of calculation regarding list initiation processing and list update processing of the present example embodiment is smaller than an amount of calculation regarding list generation processing upon generating an execution TU list from the beginning, for example, by calculating a partial sum. Therefore, the transform processing unit 3000 of the present example embodiment can reduce threads necessary for transform/quantization by using a smaller amount of calculation.

### Sixth Example Embodiment

### [Configuration]

In general, when an accelerator accompanying a CPU such as a GPU is used, data transfer between a CPU and a GPU via a bus is necessary, and therefore a transfer time generated in the data transfer tends to be a large bottleneck. A data transfer speed, for example, in Peripheral Component Interconnect (PCI) Express that is a bus communication standard generally used is lower by one to two orders of magnitude than a data transfer speed to a memory inside a CPU or a GPU.

The technique described in PTL 3 stores, with respect to only a non-zero value, a transform coefficient included in a block after transform/quantization processing in the block by being divided into position information and a value. As described above, a large number of transform coefficients indicates “0” after transform/quantization processing, and therefore the technique described in PTL 3 can compress data and a data transfer speed can be expected to be improved. The technique described in PTL 3 performs division into blocks including a predetermined number of pixels that is an execution unit of parallel processing and thereby can process each block in parallel. The technique described in PTL 3 sequentially scans, when compressing a block, transform coefficients in the block and reduces the number of bits of transform coefficients by thinning all transform coefficients in the block when the number of non-zero coefficients exceeds a threshold, and thereby reduces a data size necessary for storing transform coefficients.

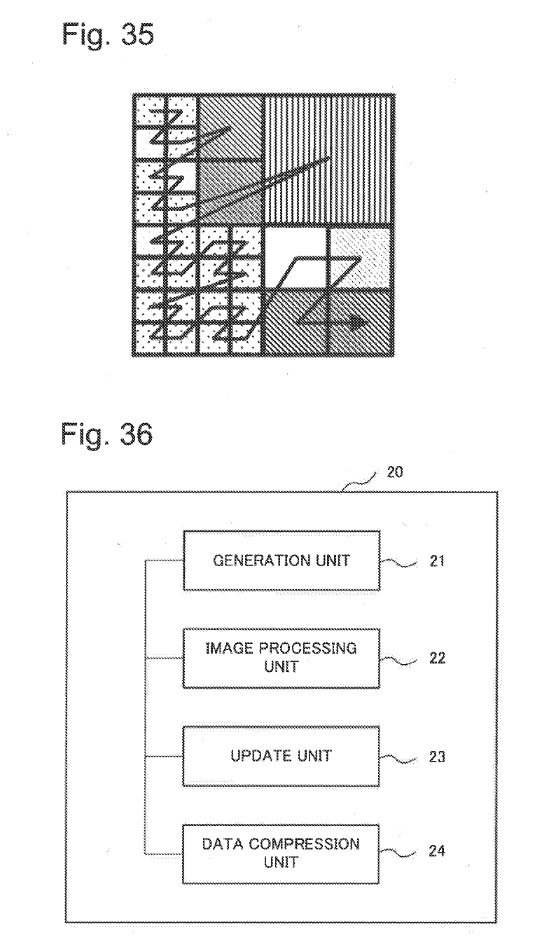

When the present technique is applied to H.265, a block referred to here is preferably a TU upon considering an influence on a pixel when data are thinned. By doing in such a manner, compression processing is executed for each TU. In addition, while being not referred to in PTL 3, a TU is preferably compressed in a processing order in encoding processing of a subsequent stage (so-called Z scan), as illustrated in FIG. 35.

Note that, as described above, after transform/quantization, a large number of non-significant TUs, i.e. TUs in which a transform coefficient is not “0” are generated, and therefore compression processing may be executed for only significant TUs. In this case, an encoding unit can identify, upon encoding, a position of each TU by using TU size information and a CBF in a frame. Alternatively, in order to more simply calculate a position of a TU, position information of a TU corresponding to compressed data may be added.

Compression processing includes processing of scanning transform coefficients in a TU. Further, the number of pieces of data to be scanned (and a length of time necessary for scanning) is different depending on a TU size. Therefore, when a TU size is different, processing executed for the TU is also different, and therefore coexistence of different TU sizes generated in transform/quantization occurs, resulting in a decrease in efficiency of parallel processing. Therefore, also in the compression processing, processing is executed for each TU size by using a list used for transform/quantization described in the above-described first to fifth example embodiments, and thereby efficiency of parallel processing can be expected to increase.

On the other hand, when only transform coefficients of a significant TU are compressed, compressed data have a variable-length size. Therefore, in order to execute compression processing in parallel, it is necessary to previously calculate a position of a write destination of compressed data. It is possible for TUs to be non-significant TUs after transform/quantization processing, and therefore it is necessary to calculate a compression order after transform/quantization processing. However, the respective TUs at that time have been classified for each TU size, based on a list, and therefore it is difficult to calculate a compression order in consideration of TUs of all sizes as illustrated in FIG. 35. Therefore, it is necessary to calculate a compression order for compression processing and regenerate a list for compression, and therefore this matter may be a large bottleneck.

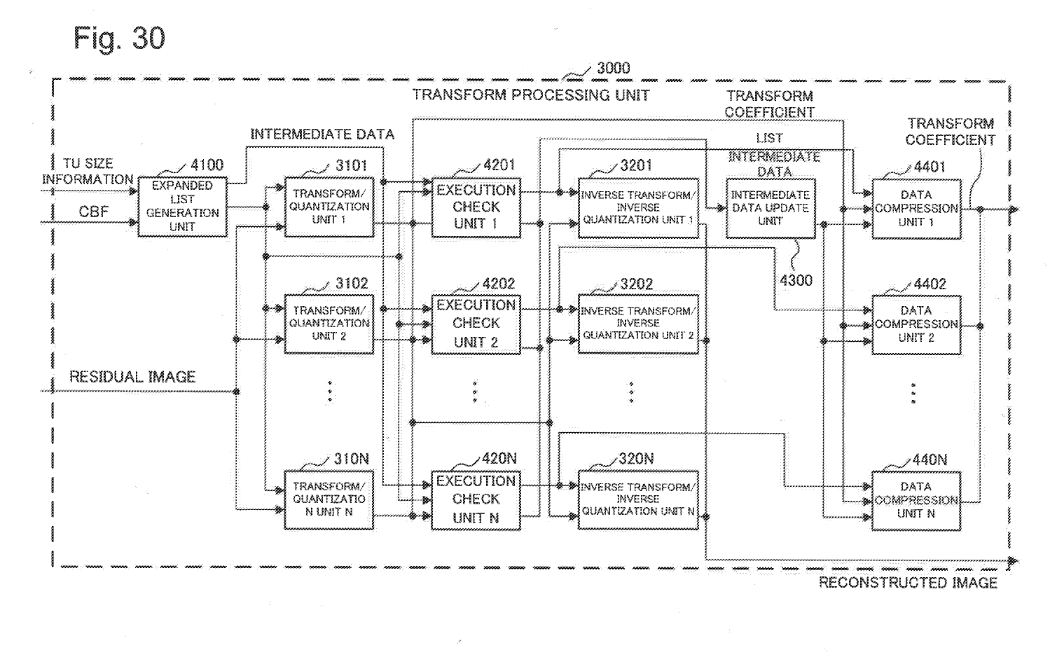

A sixth example embodiment of the present invention will be described below with reference to the drawings. FIG. 30 is a block diagram illustrating a configuration example of a transform processing unit according to the sixth example embodiment of the present invention. Note that, while TU size patterns of H.265 are four types of 4×4, 8×8, 16×16, and 32×32, it is assumed that TU size patterns of the present example embodiment are N types.

As illustrated in FIG. 30, a transform processing unit 3000 of a video image encoding device of the present example embodiment includes an expanded list generation unit 4100 instead of the list generation unit 3300, differently from the transform processing unit 3000 illustrated in FIG. 6. Further, the transform processing unit 3000 includes an intermediate data update unit 4300 and data compression units 4401 to 440N. Further, intermediate data are input/output to/from execution check units 4201 to 420N, differently from the execution check units 3401 to 340N of the transform processing unit 3000 illustrated in FIG. 6. A configuration of the transform processing unit 3000 illustrated in FIG. 30 is similar to the configuration of the transform processing unit 3000 illustrated in FIG. 6, except a configuration of the expanded list generation unit 4100, the execution check units 4201 to 420N, the intermediate data update unit 4300, and the data compression units 4401 to 440N.

The transform processing unit 3000 of the present example embodiment has one feature that using an execution TU list and intermediate data, transform coefficients to be transferred to a CPU are compressed.

The expanded list generation unit 4100 includes a function of accepting input of TU size information and CBFs and outputting an expanded list and intermediate data. As elements of the expanded list, in addition to position information of a TU described above, position information of a 4×4 block unit corresponding to intermediate data of a 4×4 block unit is stored. The position information of a 4×4 block unit refers to information for identifying a position of intermediate data and is, for example, an index.

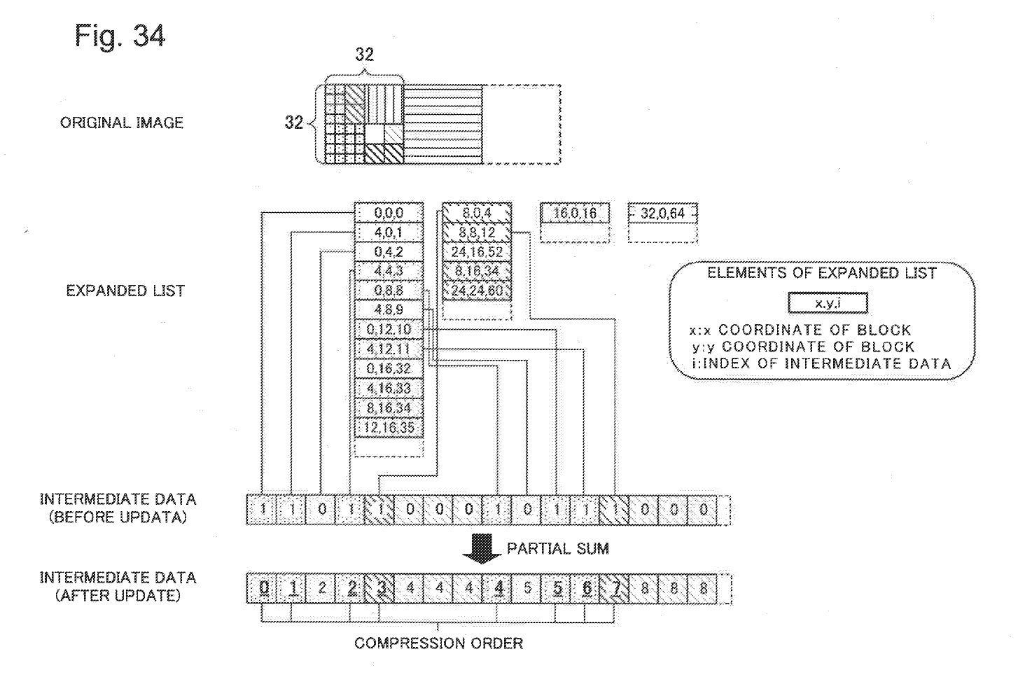

An expanded list and intermediate data are associated with each other by an index of the intermediate data exemplarily illustrated in FIG. 34. In other words, an index of intermediate data makes it possible to access intermediate data corresponding to the index from an expanded list. In an expanded list, for example, an entry (element) in which coordinates (x,y) of a block are (0,0) corresponds to an entry having an index of “0”, i.e. a top (first) entry in intermediate data. Further, in the expanded list, an entry in which coordinates (x,y) of a block are (4,0) corresponds to an entry having an index of “1”, i.e. a next (second) entry to the top entry in the intermediate data. In this manner, an index of intermediate data represents a correspondence relation between an expanded list and intermediate data. Note that, an index of intermediate data exemplarily illustrated in FIG. 34 is an index in which an offset to be described later is “0”.

Further, intermediate data are described using an example generated in a 4×4 unit herein, but there is no limitation thereto. Intermediate data may be data capable of having a correspondence relation with each TU. “Position information of a 4×4 block unit” and an “index” are information indicating a correspondence relation between an expanded list and intermediate data and are equivalent to one example of “correspondence information” in the present invention.

The execution check units 4201 to 420N accept input of an expanded list and intermediate data output from the expanded list generation unit 4100 and transform coefficients output from the transform/quantization units 3101 to 310N. The execution check units 4201 to 420N include a function of scanning a transform coefficient of a TU indicated by each entry of the expanded list, confirming whether the TU is non-significant, and writing flag information to intermediate data indicated by an index in the entry.

The intermediate data update unit 4300 includes a function of accepting input of intermediate data and CBFs after transform/quantization, updating the intermediate data, and outputting the updated intermediate data. The updated intermediate data store a compression order relating to the data compression units 4401 to 440N. The expanded list generation unit 4100 divides an expanded list into a plurality of lists for each block size. On the other hand, the intermediate data update unit 4300 updates, without being based on an expanded list, intermediate data in such a way that there is a compression order of each block in a link destination described in an entry of an expanded list corresponding to each block, and thereby can update a compression order without using an expanded list divided for each block size.

Specifically, the intermediate update unit 4300 stores, based on an execution flag included in intermediate data, a compression order of each block in intermediate data indicated by an index described an entry of an expanded list of each block. Herein, processing as described above can be realized by calculating, when execution is “1” and non-execution is “0” in an entry of an execution flag included in intermediate data, a partial sum of respective entries of execution flags included in the intermediate data. The partial sum can be efficiently calculated in parallel using Parallel Scan as described above. Note that update of intermediate data by the intermediate data update unit 4300 may be rewrite of an execution flag in a compression order or may be write of a compression order in addition to an execution flag.

Further, the intermediate data update unit 4300 calculates a partial sum similarly to the expanded list generation unit 4100 and thereby can update intermediate data in parallel. Herein, the intermediate data update unit 4300 operates in parallel for any fixed-length area. When, for example, a screen is provided to the intermediate data update unit 4300 by being divided into 32×32 blocks as an area, the intermediate data update unit 4300 can process in parallel each 32×32 block in the screen.

The data compression units 4401 to 440N refer to, using an expanded list and intermediate data, intermediate data corresponding to an entry of the expanded list, collectively compress data for each block size, and output the compressed data. Therefore, similarly to the transform/quantization units 3101 to 310N and the inverse transform/inverse quantization units 3201 to 320N, when the data compression units 4201 to 420N are realized by an SIMT architecture such as a GPU, blocks having the same size are allocated to a warp, and parallel processing is efficiently executed.

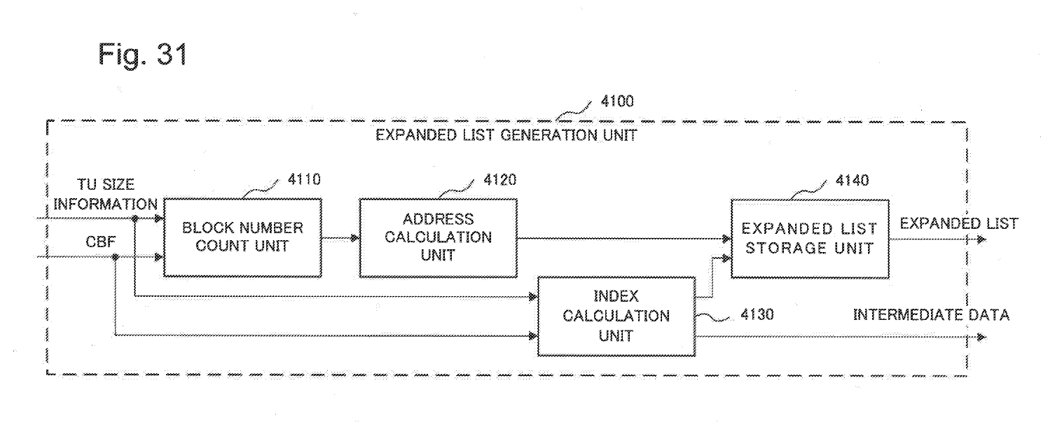

FIG. 31 is a block diagram illustrating a configuration example of the expanded list generation unit 4100. As illustrated in FIG. 31, the expanded list generation unit 4100 includes an index calculation unit 4130. Further, the expanded list generation unit 4100 is different from the list generation unit 3300 illustrated in FIG. 2 in points that the list storage unit 3330 is replaced with an expanded list storage unit 4140 and output includes an expanded list and intermediate data. A configuration of a block number count unit 4110 and an address calculation unit 4120 is similar to the list generation unit 3300 illustrated in FIG. 2. However, the address calculation unit 4120 calculates an address of an expanded list, instead of an address of the above-described list.

The index calculation unit 4130 includes a function of calculating, as an index, position information of a 4×4 block unit of a target block. The index calculation unit 4130 offsets information (relative position information) indicating, for example, a relative position of each block in an area (handled area) handled by a certain thread by a value obtained by multiplying a value for identifying each thread such as a thread ID by the number of blocks in the area, and thereby can easily calculate position information of a 4×4 block unit.

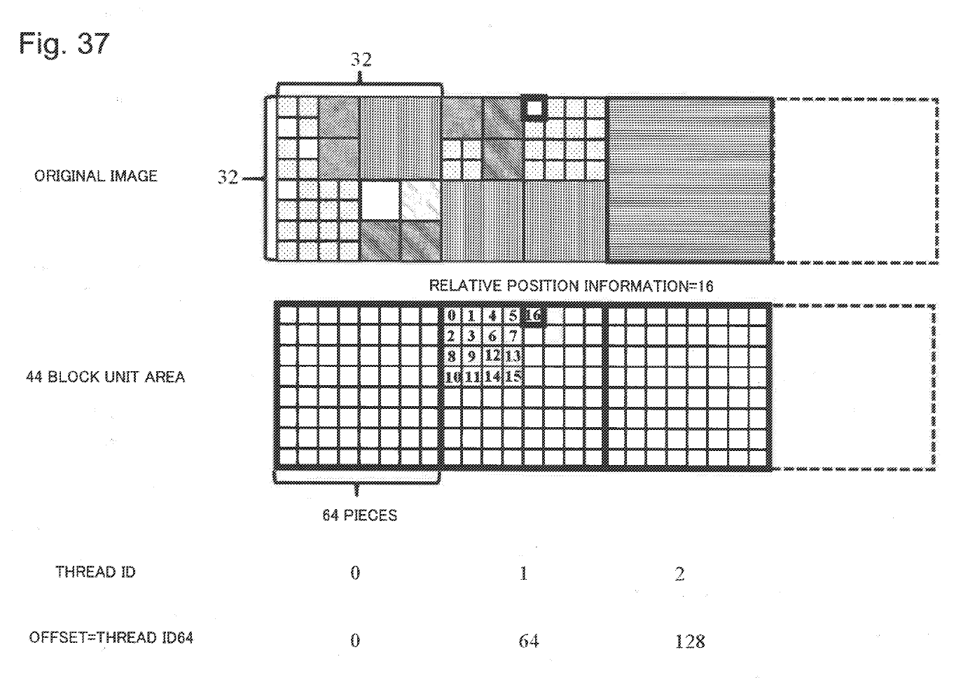

FIG. 37 is a diagram illustrating one example of a calculation method for an index including an offset. In the example, an index of a block where relative position information in a handled area of a thread ID “1” is “16” is a value obtained by adding, as an offset, a product of a thread ID (1) and the number of blocks (64) to a value (16) of the relative position information, i.e. “80”. Note that, in an index exemplarily illustrated in FIG. 34, a thread ID is “0”, and therefore an offset is also “0”.

The expanded list storage unit 4140 includes a function of accepting input of an address of a storage destination of an expanded list calculated by the address calculation unit 4120 and an index calculated by the index calculation unit 4130 and storing, as list data, position information of a block and an index in the address of the storage destination of the expanded list.

### [Operation]

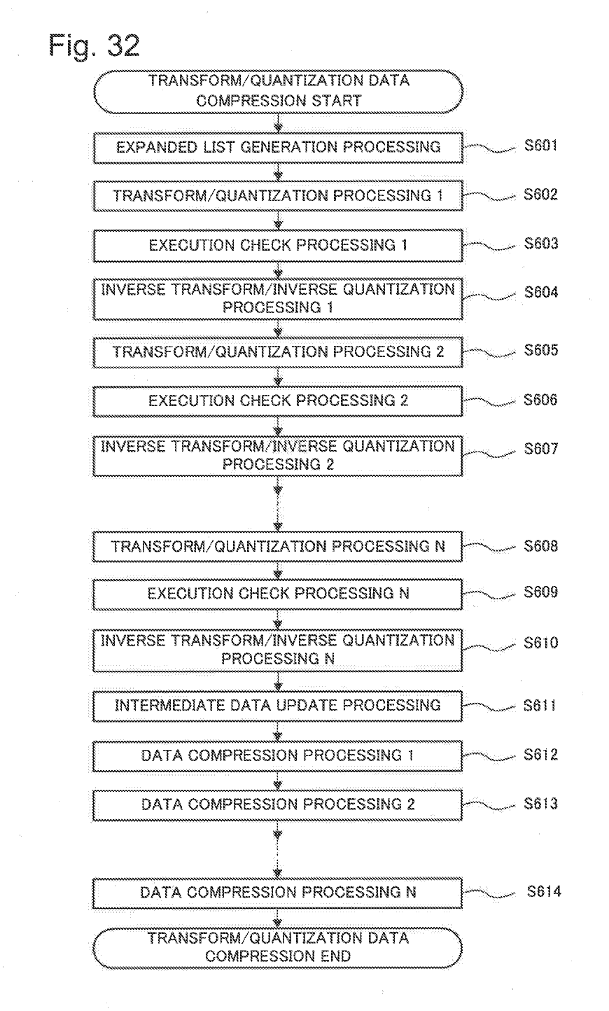

An operation of the transform processing unit 3000 of the present example embodiment will be described below with reference to FIG. 32. FIG. 32 is a flowchart illustrating transform/quantization processing and data compress processing executed by the transform processing unit 3000 of the sixth example embodiment.

The transform processing unit 3000 accepts input of a residual image, TU size information, and CBFs. The expanded list generation unit 4100 generates, using the input TU size information and CBFs, an expanded list in which pieces of list data including position information for intermediate data corresponding to position information of a block to be executed are listed for each block size (step S601).

Processing of step S602 is similar to the processing of step S202 illustrated in FIG. 7. In other words, the transform/quantization unit 3101 accepts input a list 1 regarding a TU size pattern 1 in an execution TU list generated by the list generation unit 3300 and a residual image and collectively executes transform/quantization processing for only TUs regarding the TU size pattern 1.

Then, the execution check unit 4201 confirms, for a list regarding the TU size pattern 1 in the expanded list generated by the expanded list generation unit 4100, whether each TU of the TU size pattern 1 has become non-significant by transform/quantization processing and writes an execution flag in an area for the TU on intermediate data by using an index described in an entry (step S603).

Processing of step S604 is similar to the processing of step S204 illustrated in FIG. 7. In other words, the inverse transform/inverse quantization unit 3201 executes inverse transform/inverse quantization processing for an input transform coefficient.

Processing of step S605 is similar to the processing of step S205 illustrated in FIG. 7. In other words, the transform/quantization unit 3101 executes transform/quantization processing.

Then, the execution check unit 4202 confirms, for a list regarding a TU size pattern 2 in the expanded list generated by the expanded list generation unit 4100, whether each TU of the TU size pattern 2 has become non-significant by transform/quantization processing and writes an execution flag in an area for the TU on intermediate data by using an index described in an entry (step S606).

Processing of step S607 is similar to the processing of step S207 illustrated in FIG. 7. In other words, the inverse transform/inverse quantization unit 3201 executes inverse transform/inverse quantization processing for an input transform coefficient.

The transform processing unit 3000 executes processing also for lists regarding a TU size pattern 3 and the following, similarly to the cases of the TU size patterns 1 and 2. The transform processing unit 3000 repeats similar processing up to a list regarding a TU size pattern N (steps S608 to S610).

Then, the intermediate data update unit 4300 accepts input of intermediate data output by the execution check units 4201 to 420N and updates the intermediate data in such a way as to be stored in intermediate data indicated by an index described in an entry of an expanded list corresponding to a compression order of each TU (step S611).

Then, the data compression unit 4401 compresses transform coefficients regarding the TU size pattern 1 among the transform coefficients of the entire screen, by using an expanded list output by the execution check unit 4201, transform coefficients output by the transform/quantization unit 3101, and intermediate data output by the intermediate data update unit 4300 (step S612).

Then, the data compression unit 4401 compresses transform coefficients regarding the TU size pattern 2 among the transform coefficients of the entire screen, by using, as input, an expanded list output by the execution check unit 4201, transform coefficients output by the transform/quantization unit 3101, and intermediate data output by the intermediate data update unit 4300 (step S613).

Data compression processing is repeatedly executed similarly for N types of TU size patterns (step S612 to step S614). After processing is executed for each of the N types of the TU size patterns, the transform processing unit 3000 ends transform processing.

Note that the transform processing unit 3000 may sequentially execute transform processing and data compression processing for each of N types of TU size patterns, as illustrated in FIG. 32 or may execute in parallel processing for each of N types of TU size patterns.

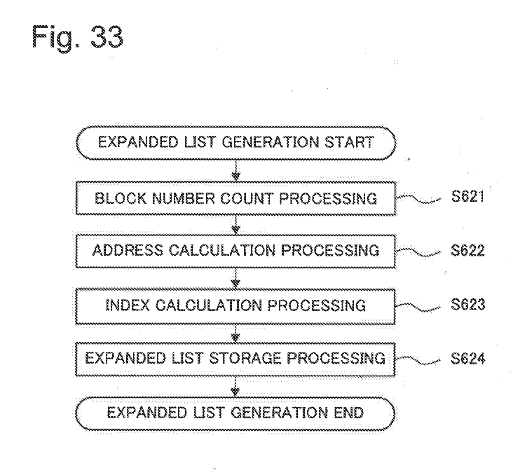

An operation of the expanded list generation unit 4100 of the present example embodiment will be described below with reference to FIG. 33. FIG. 33 is a flowchart illustrating expanded list generation processing executed by the expanded list generation unit 4100. In other words, processing of steps S621 to S624 illustrated in FIG. 33 is equivalent to the processing of step S601 illustrated in FIG. 32.

The block number count unit 4110 counts, using TU size information and CBFs, the number of blocks to be executed in an area to be processed (step S621).

Then, the address calculation unit 4120 calculates an address where an entry of an expanded list of each TU to be executed is stored, by using the number of blocks to be executed in the handled area counted by the block number count unit 4110 (step S622).

Then, the index calculation unit 4130 calculates, using TU size information and a CBF, position information of a 4×4 block unit corresponding to each block to be executed in the handled area (step S623).

Then, the expanded list storage unit 4140 generates an entry of the expanded list regarding each block to be executed in the handled area, by using the address calculated in step S622 and the index calculated in step S623 and stores the generated entry in a corresponding address (step S624). After storing entries of the expanded list regarding all blocks to be executed, the expanded list generation unit 4100 ends expanded list generation processing.

### [Advantageous Effect]

Next, an advantageous effect of the present example embodiment will be described.

The expanded list generation unit 4100 according to the present example embodiment includes a configuration of generating, for each block size, a list in which pieces of data of the same block size are stored and in addition, a configuration of storing a correspondence relation for intermediate data in an expanded list as an index common to all block sizes. Such a configuration is included, and thereby while an expanded list itself is separated for each block size, a dependence relation between block sizes can be maintained through intermediate data. Therefore, the expanded list generation unit 4100 can calculate a compression order by intermediated data from an execution flag after end of transform processing, and thereby can use a similar expanded list in transform/quantization processing and data compression processing and can reduce a calculation cost for regenerating a list.

Further, the expanded list generation unit 4100 manages data regarding all block sizes by the same intermediate data and thereby can calculate a compression order regarding all block sizes collectively at a time.

In other words, the expanded list generation unit 4100 can solve a problem that an amount of calculation for list generation is a bottleneck. Therefore, the video image processing device of the present example embodiment can execute video image processing in which an amount of calculation for list generation is reduced and thereby can realize high-speed video image processing.

The example embodiment of the video image encoding device according to the present invention is not limited to the above-described first example embodiment to the sixth example embodiment. The example embodiment of the video image encoding device according to the present invention may be an example embodiment in which, for example, another video image encoding processing executing similar processing is executed and in addition, another processing such as motion compensation prediction processing other than transform/quantization processing is executed.

Note that, while in the above-described respective example embodiments, an example in which a transform/quantization unit and the like based on the standardization of H.264 or the standardization of H.265 is realized by a GPU has been described, a video image encoding device may be realized by a parallel processor other than a GPU or hardware capable of executing parallel processing and the like.

Further, the above-described respective example embodiments can be configured with hardware and also can be realized by a computer program recorded, for example, on a recording medium.

An information processing device illustrated in FIG. 21 includes a processor 1001, a program memory 1002, a storage medium (recording medium) 1003 for storing video data, and a storage medium 1004 for storing data such as a bit stream. The storage medium 1003 and the storage medium 1004 may be separate storage media or may be storage areas including the same storage medium. As these storage media, a magnetic storage medium such as a hard disk is usable. In the storage medium 1003, at least an area that stores a program is a non-transitory tangible media.

In the information processing device illustrated in FIG. 21, the program memory 1002 stores a program for realizing a function of each block illustrated in FIGS. 1, 6, 8, 10, 17, and 30. The processor 1001 executes processing according to a program stored on the program memory 1002 and thereby realizes a function of a transform processing unit illustrated in FIGS. 1, 6, 8, 10, 17, and 30.

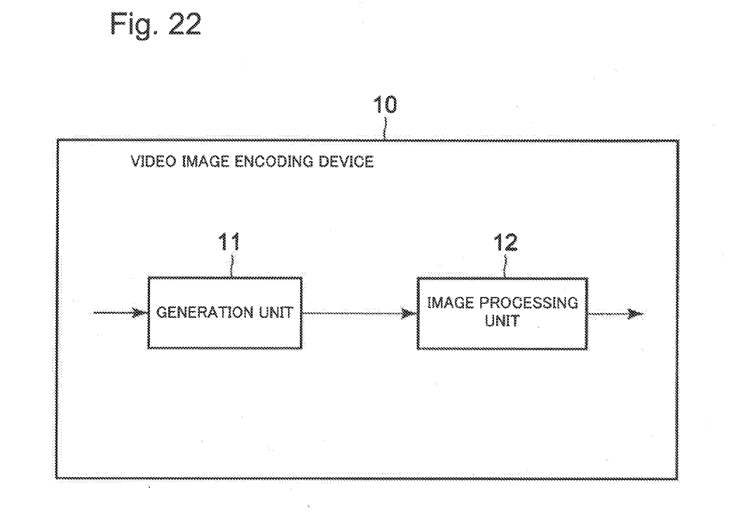

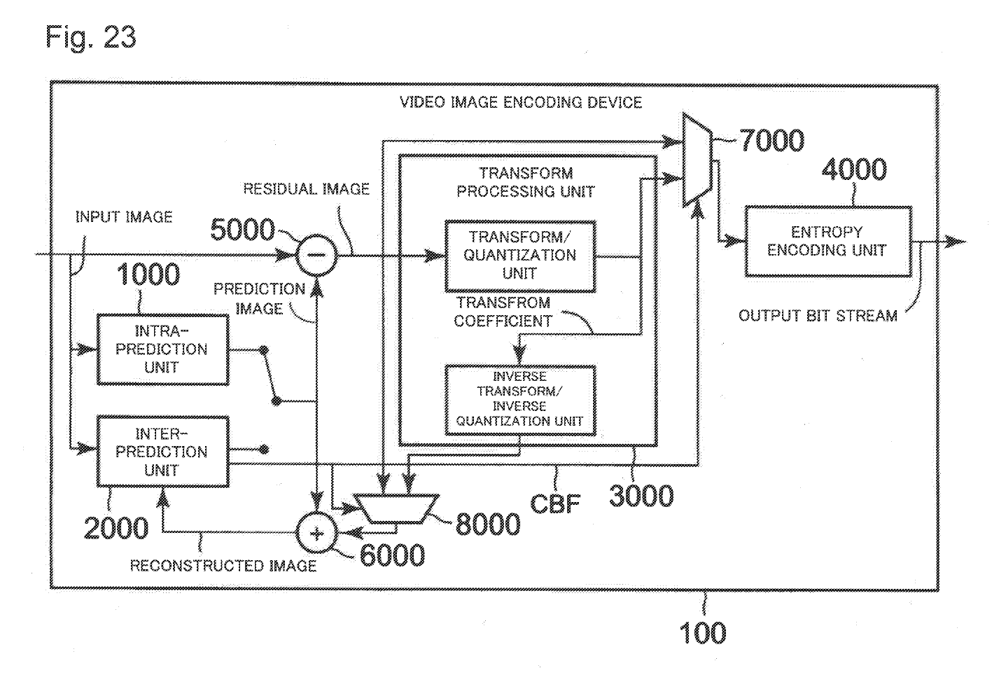

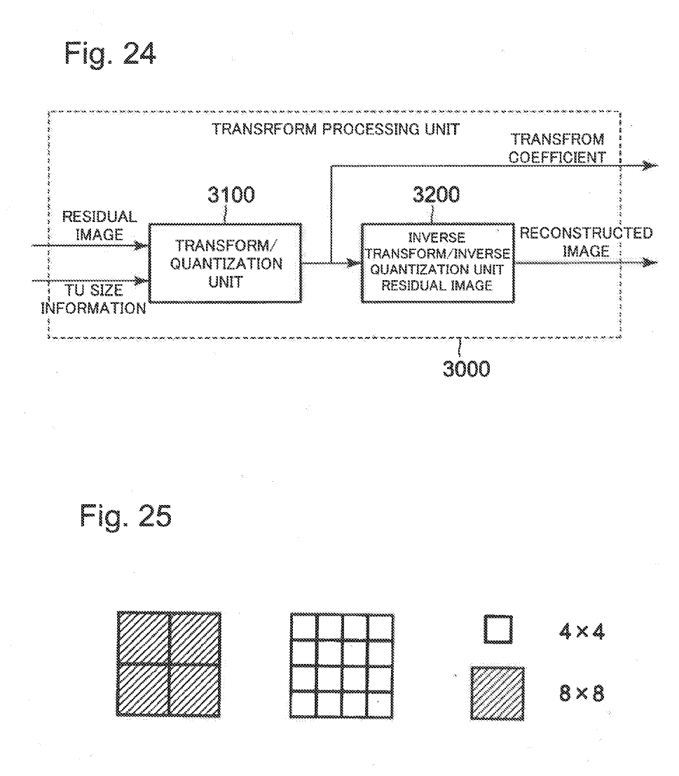

Next, an outline of the present invention will be described. FIG. 22 is a block diagram illustrating one example of an outline of the video image encoding device according to the present invention. A video image encoding device 10 according to the present invention includes a generation unit 11 (e.g. the list generation unit 3300) that generates position information indicating, for each size of an image block, a position of each of a plurality of image blocks in an image and an image processing unit 12 (e.g. the transform/quantization units 3101 to 310N and the inverse transform/inverse quantization units 3201 to 320N) that executes transform processing for an image block of a predetermined size in a position indicated by the generated position information.

Such a configuration enables the video image encoding device 10 to execute video image encoding processing in parallel, without decreasing efficiency of parallel processing.

Further, the generation unit 11 may generate position information indicating a position of an image block that is a target for transform processing and quantization processing, and the image processing unit 12 may include a transform/quantization unit (e.g. the transform/quantization units 3101 to 310N) that executes transform processing and quantization processing for an image block of a predetermined size by referring to the position information and an inverse transform/inverse quantization unit (e.g. the inverse transform/inverse quantization units 3201 to 320N) that executes inverse quantization processing and inverse transform processing for the processing result of the transform/quantization unit.

Such a configuration enables the video image encoding device to reduce threads necessary for transform processing and quantization processing.

Further, the inverse transform/inverse quantization unit may execute inverse quantization processing and inverse transform processing for a processing result other than 0.

Such a configuration enables the video image encoding device to reduce an amount of calculation regarding inverse quantization processing and inverse transform processing.

Further, the image processing unit 12 may include a second generation unit (e.g. the list generation unit 3500) that generates second position information indicating, for each size of an image block, a position of an image block that is a target for inverse quantization processing and inverse transform processing by using a processing result of a transform quantization unit, and an inverse transform/inverse quantization unit may execute inverse quantization processing and inverse transform processing for the processing result of the transform/quantization unit corresponding to the image block that is a target for inverse quantization processing and inverse transform processing by referring to the second position information.

Such a configuration enables the video image encoding device to reduce threads necessary for inverse quantization processing and inverse transform processing.

Further, the image processing unit 12 may include a third generation unit (e.g. the list update unit 3600) that generates, by updating position information generated by the generation unit 11, third position information continuously including information indicating a position of an image block that is a target for inverse quantization processing and inverse transform processing, by using a processing result of a transform/quantization unit. In this case, an inverse transform/inverse quantization unit may execute inverse quantization processing and inverse transform processing, for each predetermined unit, for the processing result of the transform/quantization unit corresponding to the image block that is a target for inverse quantization processing and inverse transform processing by referring to the third position information.

Such a configuration enables the video image encoding device to reduce warps necessary for inverse quantization processing and inverse transform processing.

Further, the generation unit 11 (e.g. the list initiation unit 3700 and the list update unit 3800) may generate position information continuously including information indicating a position of an image block that is a target for transform processing and quantization processing, and the image processing unit 12 may include a transform/quantization unit that executes, for each predetermined unit, transform processing and quantization processing for an image block of a predetermined size by referring to the position information and an inverse transform/inverse quantization unit that executes inverse quantization processing and inverse transform processing for the processing result of the transform/quantization unit.

Such a configuration enables the video image encoding device to reduce warps necessary for transform processing and quantization processing.

Further, the generation unit 11 may generate in parallel position information, based on each image area that is a piece of divided image data.

Such a configuration enables the video image encoding device to execute list generation processing in parallel for a residual image.

FIG. 36 is a block diagram illustrating another example of an outline of the video image encoding device according to the present invention. A video image encoding device 20 includes a generation unit 21 (e.g. the expanded list generation unit 4100), an image processing unit 22 (e.g. the transform/quantization units 3101 to 310N), an update unit 23 (e.g. the intermediate data update unit 4300), and a data compression unit 24 (e.g. the data compression units 4401 to 440N). The generation unit 21 generates position information indicating, for each size of an image block, a position of each of a plurality of image blocks in an image and correspondence information (e.g. an index) indicating a correspondence relation between position information and data (e.g. intermediate data) in which a compression order of an image block based on the data compression unit 24 is stored. The image processing unit 22 executes transform processing for an image block of a predetermined size at a position indicated by the position information generated by the generation unit 21. The update unit 23 collectively updates the data generated by the generation unit 21, based on the result of transform processing by the image processing unit 22. The data compression unit 24 compresses an image block for each size by using the data updated by the update unit 23.

Such a configuration enables the video image encoding device to execute video image encoding processing in parallel, without decreasing efficiency of parallel processing.

### [Supplementary Notes]

The example embodiment of the present invention is not limited to the above-described example embodiments and can include a modification that can be understood by those skilled in the art. The example embodiment of the present invention may be, for example, a form in which a part or all of the above-described respective example embodiments are appropriately combined. Further, a part or all of the example embodiments of the present invention can be described as, but not limited to, the following supplementary notes.

(Supplementary Note 1)

A video image encoding device comprising:

generation means for generating position information indicating, for each size of an image block, a position of each of a plurality of image blocks in an image; and

image processing means for executing transform processing for an image block of a predetermined size at a position indicated by the generated position information.

(Supplementary Note 2)

The video image encoding device according to supplementary note 1, wherein

the generation means generates position information indicating a position of an image block being a target for transform processing and quantization processing, and

the image processing means includes transform/quantization means for executing transform processing and quantization processing for an image block of a predetermined size by referring to the position information, and inverse transform/inverse quantization means for executing inverse quantization processing and inverse transform processing for a processing result of the transform/quantization means.

(Supplementary Note 3)

The video image encoding device according to supplementary note 2, wherein

the inverse transform/inverse quantization means executes inverse quantization processing and inverse transform processing for a processing result other than 0.

(Supplementary Note 4)

The video image encoding device according to supplementary note 2 or 3, wherein

the image processing means includes second generation means for generating second position information indicating, for each size of an image block, a position of an image block being a target for inverse quantization processing and inverse transform processing by using a processing result of the transform/quantization means, and

the inverse transform/inverse quantization means executes inverse quantization processing and inverse transform processing for a processing result of the transform/quantization unit, corresponding to an image block being a target for inverse quantization processing and inverse transform processing by referring to the second position information.

(Supplementary Note 5)

The video image encoding device according to supplementary note 2 or 3, wherein

the image processing means includes third generation means for generating, by updating position information generated by the generation means, third position information continuously including information indicating a position of an image block being a target for inverse quantization processing and inverse transform processing by using a processing result of the transform/quantization means, and

the inverse transform/inverse quantization means executes inverse quantization processing and inverse transform processing, in each predetermined unit, for a processing result of the transform/quantization means, corresponding to an image block being a target for inverse quantization processing and inverse transform processing by referring to the third position information.

(Supplementary Note 6)

The video image encoding device according to supplementary note 1, wherein

the generation means generates position information continuously including information indicating a position of an image block being a target for transform processing and quantization processing, and

the image processing means includes transform/quantization means for executing, in each predetermined unit, transform processing and quantization processing for an image block of a predetermined size by referring to the position information, and inverse transform/inverse quantization means for executing inverse quantization processing and inverse transform processing for a processing result of the transform/quantization means.

(Supplementary Note 7)

The video image encoding device according to any one of supplementary notes 1 to 6, wherein

the generation means generates the position information and correspondence information indicating a correspondence relation between the position information and data in which a compression order of the image block is stored, and

the video image encoding device further comprises:

update means for collectively updating the data, based on a result of the transform processing; and

data compression means for compressing the image block for each size of the image block by using the updated data.

(Supplementary Note 8)

A video image encoding method comprising:

generating position information indicating, for each size of an image block, a position of each of a plurality of image blocks in an image; and

executing transform processing for an image block of a predetermined size at a position indicated by the generated position information.

(Supplementary Note 9)

The video image encoding method according to supplementary note 8, further comprising:

generating position information indicating a position of an image block being a target for transform processing and quantization processing;

executing transform processing and quantization processing for an image block of a predetermined size by referring to the position information; and

executing inverse quantization processing and inverse transform processing for a processing result of the transform processing and quantization processing.

(Supplementary Note 10)

A computer-readable program recording medium recording a program causing a computer to execute:

generation processing of generating position information indicating, for each size of an image block, a position of each of a plurality of image blocks in an image; and

transform processing for an image block of a predetermined size at a position indicated by the position information.

(Supplementary Note 11)

The program recording medium according to supplementary note 10, the program causing a computer to further execute:

generation processing of generating position information indicating a position of an image block being a target for the transform processing and quantization processing;

transform/quantization processing of executing transform processing and quantization processing for an image block of a predetermined size by referring to the position information; and

executing inverse transform/inverse quantization processing of executing inverse quantization processing and inverse transform processing for a processing result of the transform/quantization processing.

This application is based upon and claims the benefit of priority from Japanese patent application No. 2015-211659, filed on Oct. 28, 2015 and Japanese patent application No. 2016-153570, filed on Aug. 4, 2016, the disclosures of which are incorporated herein in their entirety by reference.

### INDUSTRIAL APPLICABILITY

The present invention can execute video image encoding at high speed without decreasing parallel processing efficiency and realize high-speed processing for a high-resolution video. Therefore, the present invention is preferably applicable to an image capture system, a transcode system and the like that need high-resolution processing.

### REFERENCE SIGNS LIST

11, 20, 100 Video image encoding device

11 Generation unit

12 Image processing unit

1000 Intra-prediction unit

1001 Processor

1002 Program memory

1003, 1004 Storage medium

2000 Inter-prediction unit

3000 Transform processing unit

3100 to 310N Transform/quantization unit

3200 to 320N Inverse transform/inverse quantization unit

3300 List generation unit

3310 Count unit

3320 Address calculation unit

3330 List storage unit

3401 to 340N, 4201 to 420N Execution check unit

3500 List generation unit

3600 List update unit

3610, 3710 TU execution check unit

3620 List migration unit

3700 List initiation unit

3720 Entry generation unit

3800 List update unit

3900 Gather unit

3910, 3920 Scatter unit

4000 Entropy encoding unit

4100 Expanded list generation unit

4300 Intermediate data update unit

4401 to 440N Data compression unit

5000 Subtractor

6000 Adder

7000, 8000 Multiplexer

1. A video image encoding device comprising:
a generator that generates position information indicating, for each size of an image block, a position of each of a plurality of image blocks in an image; and
an image processor that executes transform processing for an image block of a predetermined size at a position indicated by the generated position information.

2. The video image encoding device according to claim 1, wherein
the generator generates position information indicating a position of an image block being a target for transform processing and quantization processing, and
the image processor executes transform processing and quantization processing for an image block of a predetermined size by referring to the position information, and executes inverse quantization processing and inverse transform processing for a processing result of the transform/quantization processing.

3. The video image encoding device according to claim 2, wherein
the image processor executes inverse quantization processing and inverse transform processing for a processing result other than 0.

4. The video image encoding device according to claim 2, wherein
the image processor generates second position information indicating, for each size of an image block, a position of an image block being a target for inverse quantization processing and inverse transform processing by using a processing result of the transform/quantization processing, and
executes inverse quantization processing and inverse transform processing for a processing result of the transform/quantization processing, corresponding to an image block being a target for inverse quantization processing and inverse transform processing by referring to the second position information.

5. The video image encoding device according to claim 2, wherein
the image processor generates, by updating position information generated by the generator, third position information continuously including information indicating a position of an image block being a target for inverse quantization processing and inverse transform processing by using a processing result of the transform/quantization processing, and
executes inverse quantization processing and inverse transform processing, in each predetermined unit, for a processing result of the transform/quantization processing, corresponding to an image block being a target for inverse quantization processing and inverse transform processing by referring to the third position information.

6. The video image encoding device according to claim 1, wherein
the generator generates position information continuously including information indicating a position of an image block being a target for transform processing and quantization processing, and
the image processor executes, in each predetermined unit, transform processing and quantization processing for an image block of a predetermined size by referring to the position information, and executes inverse quantization processing and inverse transform processing for a processing result of the transform/quantization processing.

7. The video image encoding device according to claim 1, wherein
the generator generates the position information and correspondence information indicating a correspondence relation between the position information and data in which a compression order of the image block is stored, and
the image processor:
collectively updates the data, based on a result of the transform processing; and
compresses the image block for each size of the image block by using the updated data.

8. A video image encoding method comprising:
generating position information indicating, for each size of an image block, a position of each of a plurality of image blocks in an image; and
executing transform processing for an image block of a predetermined size at a position indicated by the generated position information.

9. The video image encoding method according to claim 8, further comprising:
generating position information indicating a position of an image block being a target for transform processing and quantization processing;
executing transform processing and quantization processing for an image block of a predetermined size by referring to the position information; and
executing inverse quantization processing and inverse transform processing for a processing result of the transform processing and quantization processing.

10. A non-transitory computer-readable program recording medium recording a program causing a computer to execute:
generation processing of generating position information indicating, for each size of an image block, a position of each of a plurality of image blocks in an image; and
transform processing for an image block of a predetermined size at a position indicated by the position information.

11. The program recording medium according to claim 10, the program causing a computer to further execute:
generation processing of generating position information indicating a position of an image block being a target for the transform processing and quantization processing;
transform/quantization processing of executing transform processing and quantization processing for an image block of a predetermined size by referring to the position information; and
executing inverse transform/inverse quantization processing of executing inverse quantization processing and inverse transform processing for a processing result of the transform/quantization processing.
